(19) United States
(12) Patent Application Publication
(10) Pub. No.: US 2024/0262978 A1
(43) Pub. Date: Aug. 8, 2024

(54) THERMALLY CONDUCTIVE SILICONE RUBBER WITH HIGH MECHANICAL PROPERTIES

(71) Applicant: Eaton Intelligent Power Limited, Dublin (IE)

(72) Inventors: Shahab ZEKRIARDEHANI, Union City, NJ (US); John HANA, Westland, MI (US); Ajay KRISHNAMURTHY, Farmington Hills, MI (US)

(21) Appl. No.: 18/430,354

(22) Filed: Feb. 1, 2024

Related U.S. Application Data
(60) Provisional application No. 63/443,174, filed on Feb. 3, 2023.

(51) Int. Cl. C08K 3/013; B29C 45/00; B29C 55/00; B29C 70/00; B29K 83/00; C08K 3/22; C08K 3/38

(52) U.S. Cl. CPC C08K 3/013; B29C 45/0001; B29C 55/005; B29C 70/0035; C08K 3/22; C08K 3/38; B29K 2083/005; B29K 2995/0005; C08K 2003/2227; C08K 2003/385; C08K 2201/001; C08K 2201/005

(57) ABSTRACT

A cold shrink splice article is provided comprising a thermally conductive silicone rubber composition capable of exhibiting high thermal conductivity of >0.4 W/m*K, or >0.5 W/m*K and desirable mechanical properties including >500% elongation at break.

### CROSS-REFERENCES TO RELATED APPLICATIONS

This application claims the benefit of priority to U.S. provisional application No. 63/443,174, filed Feb. 3, 2023, which is incorporated by reference herein in its entirety.

### BACKGROUND

Cold shrink splice articles can be manufactured from elastically recoverable materials for enclosing a connector or a terminal end of an electrical cable. During operation, due to current flow, the temperature of the cable and the connector increases. In addition, contact resistance at joints results in extra heat generation and can further increase the temperature. To dissipate excess heat, a thermally conductive and electrically insulating liquid silicone rubber layer can be used in the splice to improve heat dissipation and lower temperature in the connector area.

Unfilled silicone rubber tends to exhibit poor thermal conductivity. Various ceramic fillers have been used in an attempt to render the silicone rubbers thermally conductive; however, typically such high levels of the fillers have been required that the physical properties of the silicone have been compromised. For example, one problem with commercially available thermally conductive liquid silicone rubber materials is that they exhibit very low elongation at break due to the presence of conductive fillers in their formulations. This makes them undesirable for cold shrink splice applications.

Improved liquid silicone rubber compositions and materials that exhibit both high thermal conductivity and acceptable elongation at break are desirable. Thermally conductive liquid silicone rubber compositions with improved mechanical properties are desirable.

### SUMMARY

An improved cold shrink splice article is provided. The cold shrink splice article of the present disclosure is capable of substantially improved heat dissipation when shrunk onto an electrical cable or connection. The cold shrink splice may include at least one layer comprising a thermally conductive silicone rubber composition comprising: a silicone rubber; a first thermally conductive and electrically insulating filler; and a second thermally conductive and electrically insulating filler. The silicone rubber may be a liquid silicone rubber or a high consistency silicone rubber. The thermally conductive liquid silicone rubber (LSR) composition or thermally conductive high consistency rubber (HCR) composition exhibits high thermal conductivity (>0.4 W/m*K, >0.5 W/m*K, >0.6 W/m*K, or >0.7 W/m*K) and desirable mechanical properties (>500% elongation at break) after cure.

Cured thermally conductive silicone rubber compositions are provided that exhibit high thermal conductivity (>0.4 W/m*K or preferably >0.5 W/m*K) and good mechanical properties including >500% elongation at break. The silicone rubber compositions of the disclosure can exhibit >3.0 MPa, or >3.5 MPa tensile strength. The cured thermally conductive silicone rubber compositions of the disclosure can exhibit M300 modulus >0.9 MPa, >1.0 MPa, or >1.5 MPa. The thermally conductive silicone rubber compositions of the disclosure can exhibit >500% elongation at break, or >550% elongation at break. In some embodiments, dielectric constant of the thermally conductive silicone rubber may range from about 2.5 to about 5.0, or about 3.0 to about 4.0. In some embodiments, dielectric strength of the thermally conductive silicone rubber may range from about 14 to about 25 kV/mm, about 15 to about 23 kV/mm, or about 18 to about 21 kV/mm.

A shaped, stretched, and cured splice article is provided comprising an innermost layer comprising an electrically conductive silicone rubber composition; and a second layer immediately adjacent to the innermost layer, the second layer comprising a thermally conductive silicone rubber composition comprising: a silicone rubber; a first thermally conductive filler; and a second thermally conductive filler. The splice article may be a cold shrink splice article.

The silicone rubber may be selected from the group consisting of liquid silicone rubber and a high consistency silicone rubber. The liquid silicone rubber may be a two-part liquid silicone mixture comprising a cure catalyst.

The first and second thermally conductive fillers may be selected from the group consisting of aluminum oxide, aluminum hydroxide, fumed alumina, aluminum nitride, and boron nitride.

The first thermally conductive filler may be selected from the group consisting of aluminum oxide (Al₂O₃) and aluminum hydroxide (Al(OH)₃), optionally wherein the aluminum oxide is calcined aluminum oxide comprising >95%, >97%, or >98% Al₂O₃. In some cases, the first thermally conductive filler has a particle size distribution D₉₀ in a range of 3-150 micrometers, 3-120 micrometers, 3-100 micrometers, 4-80 micrometers, or 15-50 micrometers. In some cases, the first thermally conductive filler has a predominant particle shape selected from the group consisting of platelets and flakes.

The second thermally conductive filler may be a boron nitride filler. The second thermally conductive filler may have a particle size distribution D₉₀ in a range of 10-800 micrometers, 10-500 micrometers, 10-100 micrometers, or 12-50 micrometers. The second thermally conductive filler may have a predominant particle shape consisting of platelets, flakes, or a mixture thereof.

The thermally conductive silicone rubber composition may comprise 20 to 60 wt %, 30 to 55 wt %, 35 to 50 wt %, or 40 to 50 wt % of combined first and second thermally conductive fillers. The weight ratio of the first conductive filler to the second conductive filler may be in a ratio of 1:1 to 6:1, 2:1 to 5.5:1, 2:1 to 5.25:1, 3:1 to 5:1.

The thermally conductive silicone rubber composition may comprise 40 to 80 wt %, 45 to 70 wt %, 50 to 65 wt %, or 50-60 wt % of the silicone rubber.

The thermally conductive silicone rubber composition may further comprise one of more additives selected from the group consisting of dyes, pigments, additional fillers, dispersants, and flame retardants.

The cured thermally conductive silicone rubber composition may exhibit a thermal conductivity of >0.3 W/m*K, >0.4 W/m*K, >0.5 W/m*K, >0.6 W/m*K, or >0.7 W/m*K by ISO 22007-2:2015 and an elongation at break of at least 500%, at least 550%, or at least 600% by ASTM D412-2021 type V.

The cured thermally conductive silicone rubber composition may exhibit a hardness in a range of 30-60 Shore A, 35-55 Shore A, or 40-50 Shore A by ASTM D2240.

The cured thermally conductive silicone rubber composition may further exhibit one or more, two or more, or three or more of the following properties: M300 modulus in a range of 0.9 to 5 MPa, 1.0-4 MPa, or >1.1 MPa; tensile strength in a range of 1.80 to 7.8 MPa, >3.0 MPa, or >3.5 MPa; dielectric constant of >2.5, >3.0, or >3.5; a hardness in a range of 30-60 Shore A, 35-55 Shore A, or 40-50 Shore A; and dielectric strength of >14 kV/mm, >15 kV/mm, >16 kV/mm, >17 kV/mm, or >18 kV/mm. The tensile strength may be determined by ASTM D412-2021 type V. The modulus may be determined by ASTM D412-2021 type V. The dielectric constant may be measured by ASTM D150. The dielectric strength may be measured by ASTM D149.

The electrically conductive liquid silicone rubber composition may exhibit a volume resistivity when tested according to DIN 53482 of <300 ohm cm, <200 ohm cm, <100 ohm cm, <75 ohm cm, or <50 ohm cm.

A shaped, stretched, and cured splice article is provided comprising at least three layers including an innermost layer comprising an electrically conductive silicone rubber composition; an intermediate layer comprising the thermally conductive silicone rubber composition; and an outer or outermost layer comprising an electrically conductive silicone rubber composition. The silicone rubber may be a liquid silicone rubber or a high consistency silicone rubber. In some cases, the splice article includes an innermost electrically conductive liquid silicone rubber layer and an outer or outermost electrically conductive liquid silicone rubber layer each independently exhibit a volume resistivity in a range of no more than 300 ohm cm, 5 ohm cm to 300 ohm cm, 10 ohm cm to 200 ohm cm, 20 ohm cm to 100 ohm cm, or <300 ohm cm, <200 ohm cm, <100 ohm cm, <75 ohm cm, or <50 ohm cm. The volume resistivity may be measured by DIN 53482.

A method of making a shaped, stretched and cured splice article is provided comprising (i) obtaining an electrically conductive silicone rubber composition; (ii) formulating a thermally conductive silicone rubber composition comprising a silicone rubber, a first thermally conductive filler, and a second thermally conductive filler to form a homogenous composition; (iii) forming the electrically conductive silicone rubber composition and the homogenous thermally conductive silicone rubber composition into a shaped article; (iv) at least partially curing the shaped article; (v) stretching the cured shaped article; and (vi) maintaining the stretched, cured article in a stretched state. In some cases, the forming comprises molding together a first inner layer comprising the electrically conductive silicone rubber composition; and a second layer comprising the homogenous silicone rubber composition. In some cases, the forming further comprises molding together the first and second layers with a third outer or outermost layer comprising an electrically conductive silicone rubber composition. In some cases, the forming comprises molding together a first inner layer comprising the electrically conductive silicone rubber composition; a second layer comprising the homogenous silicone rubber composition; and a third layer comprising an electrically conductive silicone rubber composition. In some cases, the silicone rubber composition is a liquid silicone rubber. The liquid silicone rubber may be a two-part liquid silicone mixture comprising a cure catalyst. In some cases, the silicone rubber composition is a high consistency silicone rubber.

A thermally conductive silicone rubber composition is provided comprising a silicone rubber; a first thermally conductive filler; and a second thermally conductive filler. The silicone rubber may be a liquid silicone rubber or a high consistency silicone rubber. The liquid silicone rubber may be a two-part liquid silicone mixture comprising a cure catalyst. The first and second thermally conductive fillers may be selected from the group consisting of aluminum oxide, aluminum hydroxide, fumed alumina, aluminum nitride, and boron nitride.

The first thermally conductive filler is selected from the group consisting of aluminum oxide (Al₂O₃) and aluminum hydroxide (Al(OH)₃), optionally wherein the aluminum oxide is calcined aluminum oxide comprising >95%, >97%, or >98% Al₂O₃. The first thermally conductive filler may have a particle size distribution D₉₀ in a range of 3-150 micrometers, 3-120 micrometers, 3-100 micrometers, 4-80 micrometers, or 15-50 micrometers. The first thermally conductive filler has a predominant particle shape selected from the group consisting of platelets and flakes.

The second thermally conductive filler may be a boron nitride filler. The second thermally conductive filler may have a particle size distribution D₉₀ in a range of 10-800 micrometers, 10-500 micrometers, 10-100 micrometers, or 12-50 micrometers. The second thermally conductive filler may have a predominant particle shape selected from the group consisting of platelets and flakes.

A thermally conductive silicone rubber composition is provided comprising 40 to 80 wt % of a silicone rubber, and 20 to 60 wt % of combined first and second thermally conductive fillers.

A thermally conductive silicone rubber composition is provided comprising 45 to 70 wt of a silicone rubber and 30 to 55 wt % of combined first and second thermally conductive fillers.

A thermally conductive silicone rubber composition is provided comprising 50 to 65 wt % of a silicone rubber and 35 to 50 wt % of combined first and second thermally conductive fillers.

A thermally conductive silicone rubber composition is provided comprising a ratio of the first conductive filler to the second conductive filler is in a ratio of 1:1 to 6:1, 2:1 to 5.5:1, 2:1 to 5.25:1, or 3:1 to 5:1.

A thermally conductive silicone rubber composition is provided optionally further comprising one of more additives selected from the group consisting of dyes, pigments, additional fillers, dispersants, and flame retardants.

The thermally conductive silicone rubber composition may comprise a liquid silicone rubber. The thermally conductive silicone rubber composition may comprise a high consistency silicone rubber.

The cured thermally conductive silicone rubber composition may be electrically insulating. The cured thermally conductive and electrically insulating silicone rubber composition may exhibit a dielectric constant >2.5, >3.0, or >3.5; and a dielectric breakdown strength of >14 kV/mm, >15 kV/mm, >16 kV/mm, >17 kV/mm, or >18 kV/mm. The cured thermally conductive and electrically insulating silicone rubber composition may exhibit a thermal conductivity of >0.3 W/m*K, >0.4 W/m*K, >0.5 W/m*K, >0.6 W/m*K, or >0.7 W/m*K, and an elongation at break of at least 500%, at least 550%, or at least 600%. The cured thermally conductive and electrically insulating silicone rubber composition may exhibit M300 modulus in a range of 0.9 to 5 MPa, 1.0-4 MPa, or >1.1 MPa; and a tensile strength in a range of 1.80 to 7.8 MPa, >3.0 MPa, or >3.5 MPa.

### BRIEF DESCRIPTION OF THE DRAWINGS

FIG. 1A shows an embodiment of an innermost layer of a cold shrink splice according to the present disclosure, the innermost layer comprising an electrically conductive silicone rubber composition.

FIG. 1B shows an embodiment of a middle layer of a cold shrink splice according to the present disclosure, the middle layer comprising a thermally conductive silicone rubber composition according to the disclosure.

FIG. 1C shows an embodiment of an outer or outermost layer of a cold shrink splice according to the present disclosure, the outer or outermost layer comprising an electrically conductive silicone rubber composition.

FIG. 2 shows a cutaway drawing of a partially constructed cold shrink splice according to the present disclosure showing inner electrically conductive silicone rubber layer 440 and middle thermally conductive silicone rubber 450 layers.

FIG. 3A shows one view of an embodiment of a cold shrink splice 500 according to the disclosure including innermost layer 100, intermediate layer 200, and outer layer 300.

FIG. 3B shows a cutaway longitudinal view of an embodiment of a cold shrink splice 500 according to the disclosure including innermost layer 100, intermediate layer 200, and outer layer 300.

FIG. 3C shows one view showing the outward appearance of a cold shrink splice 500 according to the disclosure. The outer layer 300 completely encompasses an innermost layer and an intermediate layer (not visible). An endview of the cold shrink splice 510 illustrates the hollow, sleeve-like nature of the splice.

### DETAILED DESCRIPTION OF THE INVENTION

Silicone rubber materials without fillers tend to be non-thermally conductive materials. In order to improve their thermal conductivity, conductive fillers can be dispersed into the silicone rubber composition matrix. However, inclusion of thermally conductive fillers in silicone rubber matrix can result in significant reduction in the mechanical properties of the cured compositions.

The present disclosure provides a silicone rubber composition which when incorporated to a cold shrink splice according to the disclosure is capable of substantially improved heat dissipation when shrunk onto a cable or splice or connection compared to other commercially available cold shrink splice assemblies. The silicone rubber may be a liquid silicone rubber or a high consistency silicone rubber.

### Definitions

The terminology used herein is for the purpose of describing particular embodiments only and is not intended to be limiting of the disclosure.

The singular forms “a”, “an” and “the” are intended to include the plural forms as well, unless the context clearly indicates otherwise.

The term “and/or” refers to and encompasses any and all possible combinations of one or more of the associated listed items.

The term “about,” when referring to a measurable value such as an amount of a compound, dose, time, temperature, and the like, is meant to encompass variations of 10 wt %, 5 wt %, 1 wt %, 0.5 wt %, or even 0.1 wt % of the specified amount.

Unless otherwise specified, reference to “percent” or “%” refers to weight percent or wt. %.

Unless otherwise specified, the term “room temperature” is 20 deg C., as specified in ISO 1 standard.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this disclosure belongs. In the event of conflicting terminology, the present specification is controlling.

All patents, patent applications and publications referred to herein are incorporated by reference in their entirety.

The term “thermally conductive” when used to refer to a material means the material has good transfer or heat therethrough. The thermally conductive material of the present disclosure can exhibit at least >0.3 W/m*K, >0.4 W/m*K, or >0.5 W m*K thermal conductivity.

The term “elastically recoverable”, “elastically shrinkable”, and “cold shrinkable” may be used interchangeably to mean that an article is shrinkable at temperatures of about −20 deg C. to about 50 deg C. without the addition of heat.

The term “cold shrink splice” refers to an open-ended sleeve, comprising elastomers with high performance physical and/or mechanical properties, that has been factory expanded, or pre-stretched, and assembled onto a supporting removable core. For example, the removable core may be a plastic spiral core. The cold shrink splice shrinks upon removal of the supporting core during the installation process. For example, and electrician may slide the splice over a cable to be spliced or terminated and unwinds the core, causing the splice to shrink, or contract, in place.

The thermally conductive silicone rubber compositions of the present disclosure are appropriate for use in molded rubber products. Molded articles may include cold shrink splices, other cable accessories, stoppers, O-rings, sealing elements, and the like. The thermally conductive silicone rubber compositions of the present disclosure may be used in the construction of cold shrink splices and other cable accessories.

### Cold Shrink Splice

A cold shrink splice according to the disclosure may include at least one layer comprising the thermally conductive silicone rubber composition. The cold shrink splice may further include one or more layers comprising an electrically conductive silicone rubber. In some cases, a cold shrink splice is provided including an innermost layer comprising an electrically conductive silicone rubber composition, surrounded by a thicker layer comprising a thermally conductive silicone rubber composition comprising two or more thermally conductive fillers, and an outer or outermost layer that covers the first two layers comprising an electrically conductive silicone rubber composition. The silicone rubber may be a liquid silicone rubber or a high consistency silicone rubber.

In some cases, a cold shrink splice is provided including an innermost layer comprising an electrically conductive liquid silicone rubber composition, surrounded by a thicker layer comprising a thermally conductive liquid silicone rubber composition comprising two or more thermally conductive fillers, and an outer or outermost layer that covers the first two layers comprising an electrically conductive liquid silicone rubber composition.

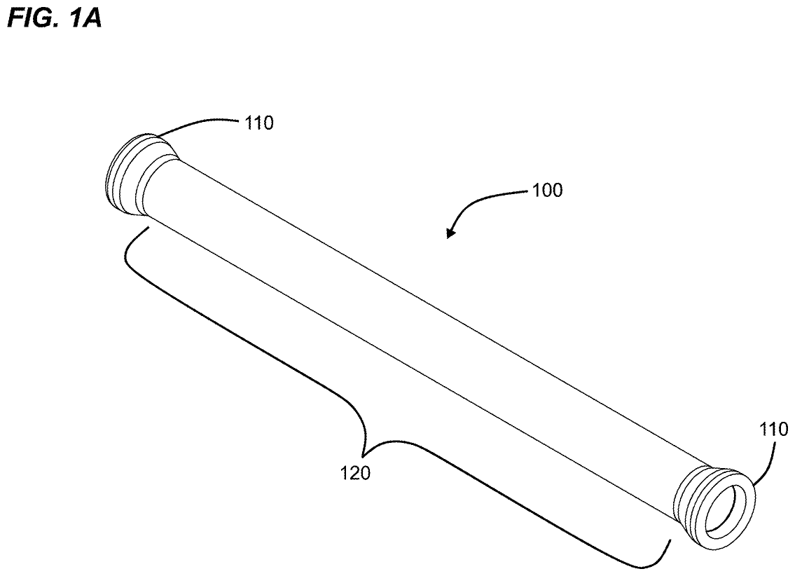

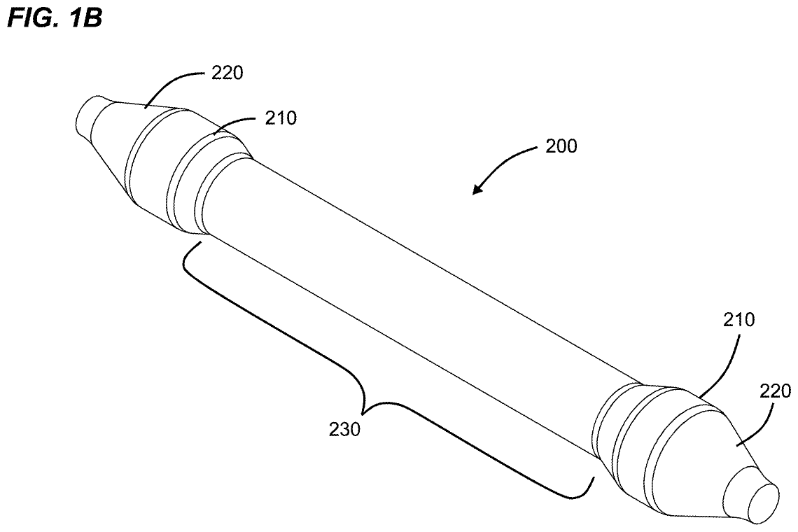

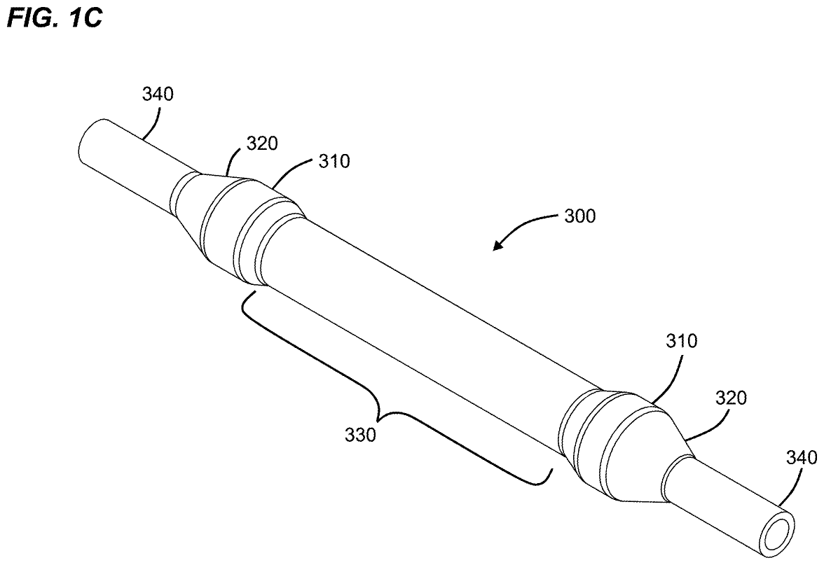

The cold shrink splice of the present disclosure may comprise one, two, or three or more layers. The cold shrink splice may include two or more layers. The cold shrink splice may include three layers. The cold shrink splice may include an innermost electrically conductive silicone rubber layer, an intermediate thermally conductive silicone rubber layer, and an outer or outermost electrically conductive silicone rubber layer. The cold shrink splice may include an innermost electrically conductive liquid silicone rubber layer, an intermediate thermally conductive liquid silicone rubber layer, and an outer or outermost electrically conductive liquid silicone rubber layer. The cold shrink splice may include an innermost electrically conductive liquid silicone rubber layer, an intermediate thermally conductive and electrically insulating liquid silicone rubber layer, and an outer or outermost electrically conductive liquid silicone rubber layer. The cold shrink splice may include an innermost electrically conductive liquid silicone rubber layer, an intermediate electrically insulating liquid silicone rubber layer, and an outer or outermost electrically conductive liquid silicone rubber layer. The cold shrink splice may include an innermost electrically conductive silicone rubber layer, an intermediate thermally conductive high consistency silicone rubber layer, and an outer or outermost electrically conductive silicone rubber layer. The cold shrink splice may include an innermost electrically conductive silicone rubber layer, an intermediate thermally conductive and electrically insulating high consistency silicone rubber layer, and an outer or outermost electrically conductive silicone rubber layer. The cold shrink splice may include an innermost electrically conductive silicone rubber layer, an intermediate electrically insulating high consistency silicone rubber layer, and an outer or outermost electrically conductive silicone rubber layer. In some cases, the disclosure provides a cold shrink splice as a unitary article including at least three layers including the innermost electrically conductive silicone rubber layer (FIG. 1A), an intermediate middle thermally conductive silicone rubber layer (FIG. 1B), and an outer or outermost electrically conductive silicone rubber layer (FIG. 1C).

The cold shrink splice of the disclosure may be provided in a radially expanded or stretched condition on a removable rigid core. The removable core may be in the form of rigid cylindrical core, helical core, spiral core, or a series of coils. The removable core may comprise any appropriate plastic material, which may be made of various materials such as, for example, polypropylene, polyvinyl chloride, polyethylene terephthalate, cellulose acetate, butyrate, and the like. The removable core may comprise a spiral or helical polypropylene removable core. The core should be rigid enough to support the splice, but to allow for manual removal of the core, and flexible enough to allow for unwinding, such as for example, a spiral plastic removable core. A removable strip may be attached to the core and can be gripped manually at one end of the splice. The coils will then separate. Manual removal of the strip allows complete removal of the core from the splice. The splice is allowed to shrink onto a connection or a terminal from one end to the other.

In some embodiments, the cold shrink splice includes an innermost (FIG. 1A) electrically conductive silicone rubber layer 100 that when in place contacts the cable and connector. As shown in FIG. 1A, the inner electrically conductive layer may have a tubular or toroidal shape with rounded or elliptical ends 110, and a central sleeve 120 that can extend over a cable connector. The electrically conductive layer may comprise an electrically conductive silicone rubber layer. The innermost electrically conductive silicone rubber layer 100 may be fully bonded or with intimate contact without full bonding to the intermediate thermally conductive silicone rubber layer 200. The electrically conductive layer may comprise an electrically conductive liquid silicone rubber layer. The electrically conductive liquid silicone rubber layer may comprise a commercially available electrically conductive liquid silicone rubber. The electrically conductive layer may comprise an electrically conductive high consistency silicone rubber layer. The electrically conductive high consistency silicone rubber layer may comprise a commercially available electrically conductive high consistency silicone rubber layer. The electrically conductive inner layer may have an average length of from about 50% to about 90% of the cold shrink splice body disposed longitudinally in the center of the body. The innermost electrically conductive liquid silicone rubber layer may exhibit a volume resistivity of no more than 300 ohm cm, 5 ohm cm to 300 ohm cm, 10 ohm cm to 200 ohm cm, 20 ohm cm to 100 ohm cm, or <300 ohm cm, <200 ohm cm, <100 ohm cm, <75 ohm cm, or <50 ohm cm. The innermost electrically conductive silicone rubber layer may exhibit at least about 300%, at least about 400%, or at least about 500% elongation at break.

In some embodiments, the cold shrink splice includes an intermediate or middle (FIG. 1B) thermally conductive silicone rubber layer 200 disposed between, and in direct contact with, the innermost electrically conductive silicone rubber layer and the outer or outermost electrically conductive silicone rubber layer. The middle or intermediate thermally conductive silicone rubber layer has a sleeve 230, annular ridges 210, and two distal opposing geometric cones 220 that surround the innermost electrically conductive silicone rubber layer and extend beyond the innermost layer in a longitudinal direction. The thermally conductive silicone rubber layer may comprise a liquid silicone rubber and one or more or two or more thermally conductive fillers and exhibit a high thermal conductivity of >0.3 W/m*K, >0.4 W/m*K, >0.5 W/m*K, >0.6 W/m*K, or >0.7 W/m*K; and at least 500%, at least 550%, or at least 600% elongation at break. In some cases, the thermally conductive silicone rubber layer may comprise a silicone rubber and one or more or two or more thermally conductive fillers and exhibits a high thermal conductivity (>0.5 W/m*K) and at least 500% elongation. In some cases, the thermally conductive silicone rubber layer may comprise a liquid silicone rubber and one or more or two or more thermally conductive fillers and exhibit a high thermal conductivity (>0.5 W/m*K) and at least 550% elongation at break. In some cases, the thermally conductive silicone rubber layer may comprise a liquid silicone rubber and combined in a range of from about 10 to about 60 wt %, or about 20 to about 55 wt %, about 30 wt % to about 55 wt %, about 35 wt % to about 55 wt %, or about 40 wt % to about 50 wt %, or about 45 wt %, about 46 wt %, about 47 wt %, about 48 wt %, about 49 wt %, or about 50 wt % of two or more thermally conductive fillers and exhibit a high thermal conductivity (>0.5 W/m*K) and at least 500% elongation at break. In some cases, the thermally conductive liquid silicone rubber layer may comprise a liquid silicone rubber and combined in a range of from about 10 to about 60 wt %, or about 20 to about 55 wt %, about 30 wt % to about 55 wt %, about 35 wt % to about 55 wt %, or about 40 wt % to about 50 wt %, or about 45 wt %, about 46 wt %, about 47 wt %, about 48 wt %, about 49 wt %, or about 50 wt % of two or more thermally conductive fillers including an aluminum oxide filler and a boron nitride filler, wherein the thermally conductive liquid silicone rubber layer exhibits a high thermal conductivity (>0.4 W/m*K, >0.5 W/m*K, >0.6 W/m*K, or >0.7 W/m*K) and at least 500%, at least 550%, or at least about 600% elongation at break. In some embodiments, the thermally conductive silicone rubber exhibits a dielectric constant in range of from about 2.5 to about 5.0, about 3.0 to about 4.0, or >2.5, >3.0, or >3.5. In some embodiments, the thermally conductive silicone rubber exhibits a dielectric strength in a range from about 14 to about 25 kV/mm, about 15 to about 23 kV/mm, about 18 to about 21 kV/mm, or >14 kV/mm, >15 kV/mm, >16 kV/mm, >17 kV/mm, or >18 kV/mm.

The cold shrink splice may include an outer or outermost (FIG. 1C) electrically conductive silicone rubber layer 300 that includes annular ridges 310, distal opposing geometric ones 320, a tubular central body 330, and extended end seals 340. The electrically conductive outer or outermost layer 300 is in direct contact with the middle thermally conductive layer 200. The electrically conductive outer or outermost layer may comprise an electrically conductive liquid silicone rubber layer. The outer or outermost electrically conductive silicone rubber layer may comprise a commercially available electrically conductive liquid silicone rubber comprising one or more electrically conductive fillers. The electrically conductive outer layer 300 may extend past the middle layer 200 longitudinally in the center of the body to create extended endseals 340. The outer or outermost electrically conductive liquid silicone rubber layer may exhibit a volume resistivity of no more than about 300 ohm cm, 5 ohm cm to 300 ohm cm, 10 ohm cm to 200 ohm cm, 20 ohm cm to 100 ohm cm, or <300 ohm cm, <200 ohm cm, <100 ohm cm, <75 ohm cm, or <50 ohm cm. The outer or outermost electrically conductive liquid silicone rubber layer may exhibit 300-1,000%, 400-1,000%, 500-1,000%, 500-800%, at least about 300%, at least about 400%, at least about 500%, or at least about 550% elongation at break. Optionally, the outer layer may include a further cover layer.

In some cases, no adhesive between layers 100 and 200 or 200 and 300 is employed. However, if the two or more layers, or three or more layers are molded together and then cured, some cross-linking between layers may occur.

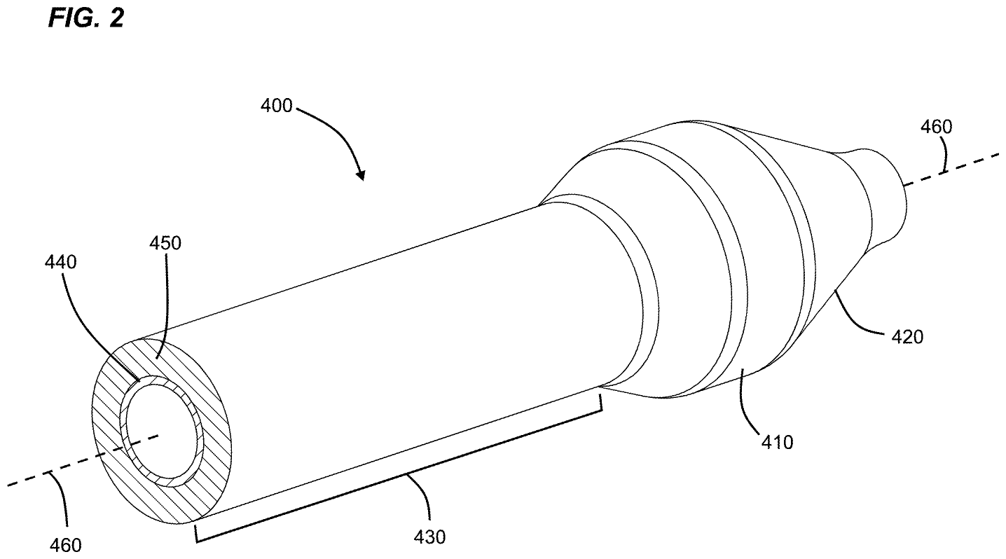

The cold shrink splice 400 may have at least two layers (FIG. 2). A thermally conductive silicone rubber layer 450 including a sleeve 430 along an axis 460, annular ridge 410, and a distal geometric cone 420 surrounds an innermost electrically conductive silicone rubber layer 440 and extends beyond the innermost layer in a longitudinal direction. In some embodiments, the thermally conductive silicone rubber layer may be encompassed by an outer electrically conductive outer layer, not shown. The thermally conductive silicone rubber layer 450 is typically thicker than the innermost electrically conductive silicone rubber layer 440.

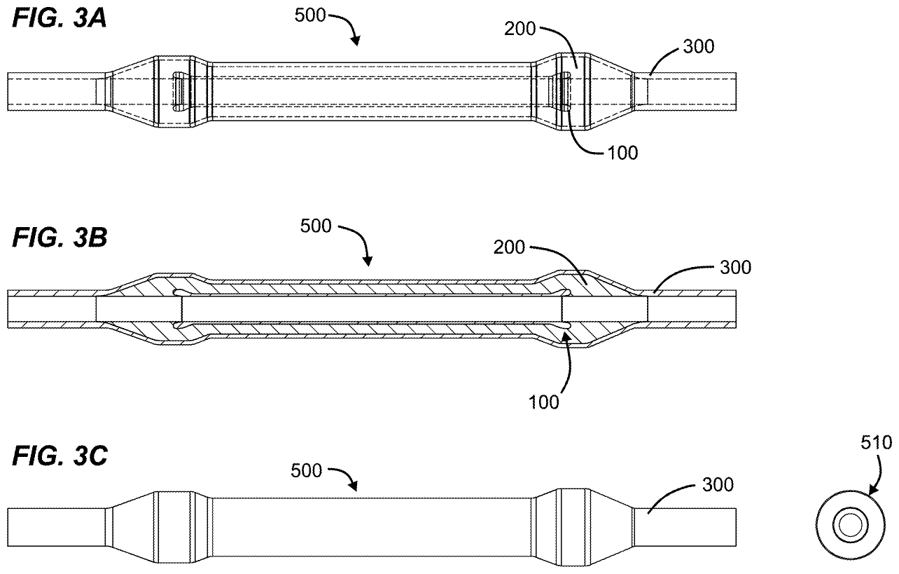

In some cases, the disclosure provides a cold shrink splice 500 as a unitary article including at least three layers (FIG. 3A) including an innermost electrically conductive silicone rubber layer 100, an intermediate middle thermally conductive silicone rubber layer 200, and an outer or outermost electrically conductive silicone rubber layer 300. In some cases, the disclosure provides a cold shrink splice 500 as a unitary article including at least three layers (FIG. 3B) wherein the thermally conductive silicone rubber layer 200 is typically thicker than the innermost electrically conductive silicone rubber layer 100. The thermally conductive silicone rubber layer 200 is typically thicker than an outer or outermost electrically conductive silicone rubber layer 300. A cold shrink splice article 500 (FIG. 3C) may appear as a unitary article including an electrically conductive outer layer 300 that extends past an intermediate layer, and inner layer, longitudinally in the center of the body. The cold shrink splice 500 comprises an endview 510 illustrating the open-ended sleeve like shape of the article.

### Silicone Rubbers

Any appropriate base rubber may be used in the compositions of the disclosure. Any appropriate base silicone rubber may be used in the compositions of the disclosure. The silicone rubber may be a liquid silicone rubber (LSR). The silicone rubber may be a high consistency silicone rubber (HCR). The silicone rubber can be a two-component system. For example, component A may include an organopolysiloxane base polymer comprising —Si-vinyl groups and a platinum catalyst. Component B may include a Si—H containing components, e.g., cross-linkers. One difference between liquid silicone rubber (LSR) and high consistency rubber (HCR) is the flowable or liquid nature of LSR materials. While HCR can use either a peroxide or platinum cure process, LSR typically uses only additive curing with platinum or platinum type catalyst.

The thermally conductive silicone rubber composition of the present disclosure may comprise any appropriate silicone rubber, for example a liquid silicone rubber (LSR) or a high consistency silicone rubber (HCR). The liquid silicone rubber may be commercially available. The liquid silicone rubber may be a two-part liquid silicone rubber. The liquid silicone rubber may be appropriate for injection molding processes. The silicone rubber may be a liquid silicone rubber commercially available as a ready-to-use mixture (of components A and B). The liquid silicone rubber may be a two-part composition curable by an addition cure mechanism. For example, composition may include a base silicone polymer which contains vinyl groups —Si—CH═CH₂, that can react with a cross linker including —Si—H hydride groups with the aid of a platinum catalyst. The base silicone polymer may comprise a polysiloxane chain. In some cases, the long chain polysiloxane chains may be reinforced with specially treated silica. The cross linker may have, for example, two or three —Si—H hydride groups per molecule. Optionally, a chain extender comprising —Si—H hydride groups may also be employed. The chain extender may have two —Si—H hydride groups. It is through this hydrosilation reaction that the material cures. A cross-linking reaction occurs between the base polymer and crosslinker.

Advantages of liquid silicone rubbers can include high biocompatibility, which is an advantage for end users. Another advantage of liquid silicone rubbers includes good durability, long-term stability, and chemical resistance. Liquid silicone rubbers typically exhibit good temperature stability over wide temperature ranges, for example, from −60 deg C. to +250 deg C. Liquid silicone rubbers can also can be pigmented over a variety of colors.

A two-part liquid silicone mixture may be cured by a cure catalyst. The catalyst may be a platinum (Pt) catalyst. The platinum catalyst may be finely divided platinum metal, extremely fine Pt powder on a carbon powder, chloroplatinic acid, platinum chelates, chloroplatinic acid-olefin products, and similar metal compounds of palladium, rhodium, iridinium, ruthenium, osmium. The catalyst may be present in from about 0.01 to about 20 parts per 100 parts organopolysiloxane.

The base liquid silicone rubber alone may exhibit a thermal conductivity of 0-0.3 W/mK, 0.05-0.3 W/mK, 0.1-0.3 W/mK, or about 0.2 W/mK; about 400-1,000%, 500-1,000%, or 700-1,000% elongation at break; and about 5-9 MPa, 6-9 MPa, or about 7-9 MPa tensile strength upon cure without the thermally conductive fillers according to the disclosure. For example, the liquid silicone rubber may be Momentive LSR Silopren™ 2030, Dow XIAMETER™ RBL 2004-20, or Wacker ELASTOSIL® 5040/20.

### Thermally Conductive Fillers

The thermally conductive silicone rubber compositions of the disclosure typically include one or more or two or more thermally conductive fillers. The thermally conductive silicone rubber compositions of the disclosure include one or more or two or more thermally conductive and electrically insulating fillers. The thermally conductive fillers may include filler types such as, for example, aluminum oxide, aluminum hydroxide, fumed alumina, aluminum nitride, boron nitride, and the like. The thermally conductive fillers may also be electrically insulating. For example, aluminum oxide (Al₂O₃) and aluminum nitride (AlN) fillers may be employed as thermally conductive and electrically insulating fillers. The thermally conductive fillers may include treated or coated fillers, e.g., including a coupling agent, sizing, amides, titanates, zirconates, or silane treatment. For example, the filler may be surface treated with silanes. The silane surface treatment may be selected from, for example, phenyltrimethoxysilane, vinyltrimethoxysilane, and the like.

The thermally conductive fillers may include filler sizes, such as, for example, in a range of 3 to 600 micrometers or 10 to 600 micrometers in diameter. The thermally conductive fillers may include filler shapes such as agglomerates, platelets, spherical shapes, and the like. The thermally conductive fillers may have a specific surface area (BET) in a range of from <10 m²/g, 2 to 4 m²/g, about 2.2 m²/g, or about 3.5 m²/g. The thermally conductive fillers may include a total thermally conductive filler concentration in the thermally conduction silicone rubber composition in a range of from about 10 to about 60 wt %, or about 20 to about 55 wt %, about 30 wt % to about 55 wt %, about 35 wt % to about 55 wt %, or about 40 wt % to about 50 wt %, or about 45 wt %, about 46 wt %, about 47 wt %, about 48 wt %, about 49 wt %, or about 50 wt %. In some cases, one or more, or two or more thermally conductive fillers may be employed in the compositions.

In some cases, the thermally conductive silicone rubber compositions of the disclosure may also be electrically insulating, for example, exhibiting a volume resistivity of >10⁹ ohm cm. In some cases, the thermally conductive silicone rubber exhibits a dielectric constant in range of from about 2.5 to about 5.0, about 3.0 to about 4.0, or >2.5, >3.0, or >3.5. In some cases, the thermally conductive silicone rubber exhibits a dielectric strength in a range from about 14 to about 25 kV/mm, about 15 to about 23 kV/mm, or about 18 to about 21 kV/mm, or >14 kV/mm, >15 kV/mm, >16 kV/mm, >17 kV/mm, or >18 kV/mm.

In some cases, the thermally conductive filler may exhibit an average particle size in a range of 3 to 600 micrometers, 10 to 600 micrometers, 10 to 200 micrometers, 10 to 100 micrometers, and 10 to 30 micrometers.

The thermally conductive filler may include an alumina filler such as a aluminum oxide filler (Al₂O₃). The alumina filler may be a commercially available aluminum oxide filler. The aluminum oxide may be a calcined aluminum oxide. Calcined alumina is aluminum oxide that has been heated at temperatures in excess of 1,050 deg C. (1,900 deg F.) to drive off nearly all chemically combined water. Depending on degree of calcination (burn) (5-100%) into alpha alumina varying from 5-100% moving it into its densest and most stable form. Calcined alumina appears as crystalline agglomerates which are larger when the degree of calcination is higher. The calcined alumina may be >95% or >99% Al₂O₃. The aluminum oxide filler may have an average particle size of, for example, 3-600 micrometers, or 10-600 micrometers. In some cases, the aluminum oxide filler or calcined alumina filler may include but is not limited to having average particle size (D₉₀) of about 18 micrometers and a max particle size (D₁₀₀) of about 45 micrometers. In some cases, the aluminum oxide filler or calcined alumina filler may include but is not limited to having particle size (D₅₀) of about 2.5 micrometers and a max particle size (D₁₀₀) of about 40 micrometers. In some cases, the aluminum oxide filler or calcined alumina filler may include but is not limited to having particle size (D₅₀) of about 2 micrometers and a max particle size (D100) of about 50 micrometers. In some cases, the aluminum oxide filler or calcined alumina filler may include but is not limited to having average particle size (D₉₀) of about 4.47 micrometers and a max particle size (D₁₀₀) of about 10 micrometers. In some cases, the aluminum oxide filler or calcined aluminum oxide filler may include but is not limited to, for example, a MARTOXID™ (Huber) alumina filler, such as MARTOXID® TM 4220, MARTOXID® TM 3220 or MARTOXID® TM 2220, and the like.

The thermally conductive filler may be an aluminum hydroxide (Al(OH)₃) or alumina trihydrate filler. The aluminum hydroxide filler may have Al(OH)₃ content of about 99%, or about 99.6%. The aluminum hydroxide filler may have a particle size (D₉₀) of 90 micrometers by laser scattering, e.g., CILAS dual light scattering particle size analyzer. The aluminum hydroxide filler may have a particle size (D₉₀) of 100 micrometers by laser scattering, e.g., CILAS dual light scattering particle size analyzer. The aluminum hydroxide filler may be selected from, for example, MARTINAL™ (Huber) aluminum hydroxide filler, such as, for example, MARTINAL® 2590, MARTINAL® 3810, and the like. The alumina filler may have a particle size distribution D50 in a range of 0.5-5 micrometers, 1-3 micrometers, or 1-2 micrometers. The aluminum hydroxide or calcined alumina filler may have a particle size distribution D₉₀ in a range of 3-150, 3-120, 3-100 micrometers, 4-80 micrometers, or 15-50 micrometers.

The thermally conductive filler may be a boron nitride (BN) filler. The boron nitride filler may be in the shape of platelets, flakes, agglomerates, a combination thereof, and the like. The boron nitride filler may be a commercially available boron nitride filler. For example, the boron nitride filler may be a 3M™ boron nitride filler platelets, or St. Gobain boron nitride filler. The boron nitride may have an average particle size of 12-25 micrometers and a surface area of <20, <15, or <10 m²/g. The boron nitride filler may have particle size distribution D50 in a range of from 5-500 micrometers, 5-100 micrometers, or 5-10 micrometers. The boron nitride filler may have particle size distribution D₉₀ in a range of 10-800 micrometers, 10-500 micrometers, 10-100 micrometers, or 12-50 micrometers.

### Electrically Conductive Silicone Rubbers

The electrically conductive silicone rubber compositions may be any appropriate electrically conductive silicon rubber composition. The electrically conductive silicone rubber may include an electrically conductive filler. The electrically conductive silicone rubber may include an electrically conductive filler such as a carbon, graphite, or silver filler, and the like. The electrically conductive silicon rubber composition may be helpful for the prevention and protection of static charge (electrostatic discharge) build-up.

In some embodiments, the electrically conductive silicone rubber compositions may include cross-linked or cross-linkable silicone rubber such as liquid silicone rubber (LSR) or high consistency silicone rubber (HCR) and an electrically conductive filler, such as a carbon or graphite filler. The electrically conductive silicone rubber compositions may be a two-part composition. The electrically conductive silicone rubber compositions may be commercially available. The electrically conductive silicone rubber compositions may include an electrically conductive two-part liquid silicone rubber. The electrically conductive two-part liquid silicone rubber may be a platinum cured two-part composition. The electrically conductive silicone rubber compositions may be suitable for injection molding. For example, the electrically conductive silicone rubber composition may comprise an ELASTOSIL® electrically conductive liquid silicone rubber composition. For example, the electrically conductive liquid silicone rubber composition may comprise SILOPREN® LSR 2345 06 (Momentive Performance Materials Inc.), ELASTOSIL® LR 3162 A/B or SQUARE® LIM1530 electrically conductive two-part liquid silicone rubber. As another example, the electrically conductive silicone rubber compositions may comprise an electrically conductive high consistency silicone rubber (HCR) such as ELASTOSIL® R 573/50 or ELASTOSIL® R 573/70. The electrically conductive liquid silicone rubber (EC LSR) composition may exhibit a volume resistivity when tested according to DIN 53482, IEC-62631-3-1, IEC60093, or ASTM D991 in a range of no more than 300 ohm cm, 5 ohm cm to 300 ohm cm, 10 ohm cm to 200 ohm cm, 20 ohm cm to 100 ohm cm, or <300 ohm cm, <200 ohm cm, <100 ohm cm, <75 ohm cm, or <50 ohm cm. The electrically conductive liquid silicone rubber (EC LSR) composition may exhibit tensile strength of >3 MPa (>3.0 N/mm²), >3.5 MPa (>3.5 N/mm²), or >5 MPa (>5 N/mm²). The electrically conductive liquid silicone composition may exhibit elongation at break of 400-1,000%, 500-1,000%, 500-800%, at least 400%, at least 450%, at least 500%, at least 550%, or at least 600%.

The electrically conductive silicone rubber compositions and/or the thermally conductive silicone rubber compositions of the disclosure may have further additives such as dyes, pigments, additional fillers, dispersants, flame retardants, and the like, so long as the additives do not interfere with the thermal or electrical properties of the compositions. The additional fillers may include reinforcing fillers, silica fillers. In some cases, the one of more additives may be present from 0-10 wt %, 0.01-8 wt %, or 1-5 wt % of the thermally conductive silicone rubber composition.

### Methods of Making

A method for making a cold shrink article is provided, the method comprising (i) forming a homogenous silicone rubber composition comprising a liquid silicone rubber and one or more, or two or more thermally conductive fillers, (ii) forming the homogenous composition unto a shaped article, (iii) curing the shaped article, (iv) stretching the cured shaped article, and (v) maintaining the stretched, cured article in a stretched state. The cold shrink article may be a cold shrink splice.

The homogenous liquid silicone rubber composition may be made by any appropriate method, for example, as follows. A two-part liquid silicone rubber mixture (of parts A and B) may be fed into a mixer. The two-part liquid silicone rubber mixture may be a ready-to-use two-part liquid silicone rubber (LSR) mixture. One or more, or two or more thermally conductive fillers may be added to either part A or part B, both part A and part B, or a mixture of part A and part B. Any appropriate ratio of part A:part B may be employed. For example, the A and B components may be mixed in a 2:1-1:2; 1.5:1-1:1.5; 1.1:1 to 1:1.1; or about a 1:1 ratio. Meter equipment may be employed to pump, meter and mix the two components preferably with little to no incorporation of air. The composition may be mixed in any appropriate mixer equipment to obtain a homogenous mixture. For example, the mixer may be a centrifugal mixer such as a Hauschild SpeedMixer® centrifugal mixer. In some cases, a centrifugal mixer may be used with a vacuum mode. The mixing may comprise use of a planetary stand kitchen style mixer, for example, a double planetary style mixer. The mixing may comprise use of a vertical shaft mixer. In some cases, the mixer may be selected from a Hobart mixer and Brabender mixer. In some cases, higher shear mixers such as kneaders and dough mixers may be possible options (for example, both available as Banbury mixers). The viscosity of the composition may be appropriate for injection molding. Viscosity may be tested by any appropriate method. In some cases, the viscosity may be tested under ASTM D1646-19a. In some cases, the viscosity is in a range of 100 to 400 Pa·s 10 s⁻¹ under ASTM D1646-19a. In some cases, the viscosity may be at least 110 Pa·s frequency 10 Hz. In some cases, viscosity may be tested under DIN 53019 test standard. In some cases, the viscosity is at least 350 Pa·s γ=10 s⁻¹ at 20° C. under DIN 53019. In some cases, the dynamic viscosity may be tested under DIN EN ISO 3219 test standard. In some cases, the viscosity, dynamic (10 s⁻¹) is at least 260 Pa·s under DIN EN ISO 3219.

The mixing may continue until a homogenous composition is obtained. In some cases, air bubbles entrapped during mixing may be degassed under vacuum.

After mixing the homogenous composition may be shaped by any appropriate method. For example, the homogenous composition may be fed into an injection mold. The mold may be a heated mold. The feeding may comprise use of a molding machine. Curing at mold temperatures of equal to or greater than 100 deg C., 140-230 deg C., 170-230 deg C., 180-220 deg C., or about 200 deg C., and/or the addition-crosslinking silicone rubber typically cures rapidly to achieve high curing speed and easy demolding. The curing time may depend on sample thickness and temperature. The curing may be partially or fully achieved within 10 seconds, 20 seconds, 30 seconds, 40 seconds, 60 seconds, 2 minutes, 3 minutes, 5 minutes, 7 minutes, 10 minutes, or 15 minutes. In some cases, curing may comprise curing for 1 min-4 hours, 5 min-2 hours, or 10 min-1 hour. In some cases, curing may comprise curing at 140 deg C. or 165 deg C. for 10 minutes. In some cases, curing may comprise curing at 175 deg C. The cure time may be inhibited by contact with certain materials such as amines, sulfur, and organotin complexes. The cured composition may or may not be subjected to post cure conditions. Any appropriate post cure conditions may optionally be employed. In some cases, post cure conditions may be at a temperature of 175-225 deg C., or about 200 deg C. for 0.5-8 h, 2 h-6 h, or about 4 h. In some cases, no post curing is required.

In some cases, the cold shrink splice comprises at least two layers including an innermost layer comprising an electrically conductive silicone rubber composition, and at least one layer comprising a thermally conductive silicone rubber composition comprising a silicone rubber, a first thermally conductive filler, and a second thermally conductive filler.

In some cases, a cold shrink splice is provided comprising at least three layers including an innermost layer comprising an electrically conductive silicone rubber composition, an intermediate layer comprising a thermally conductive silicone rubber composition comprising a silicone rubber, a first thermally conductive filler, and a second thermally conductive filler, and an outer or outermost layer comprising an electrically conductive silicone rubber composition. The intermediate layer may contact or be immediately adjacent to the innermost layer. The intermediate layer may contact or be immediately adjacent to the outer or outermost layer.

The thermally conductive silicone rubber composition may also be electrically insulating. The thermally conductive silicone rubber composition may include a liquid silicone rubber, a first thermally conductive filler, and a second thermally conductive filler. The cured thermally conductive silicone rubber composition including two or more thermally conductive fillers according to the present disclosure exhibits a high thermal conductivity (>0.3 W/m*K, >0.4 W/m*K, >0.5 W/m*k, >0.6 W/m*K, or >0.7 W/m*K) and at least 500% elongation at break.

### Mechanical Tests

### Tensile Strength

Tensile strength may be measured as the amount of force in pounds per square inch (psi) or megapascals (MPa) to pull a specimen to the point of material failure. A dumbbell shape specimen may be placed in grips or jaws of a tensometer. The tensometer pulls the grips apart steadily until the dumbbell breaks. The force at material rupture is known as ultimate tensile strength, which may be shortened to tensile strength or tensile. Tensile strength may be measured in accordance with ASTM D412 Standard Test Methods for Vulcanized Rubber and Thermoplastic Elastomers-Tension. In some cases, the tensile properties may be measured using ASTM D412 type C standard and specimen geometry. In some cases, the tensile properties may be measured using ASTM D412-2021. Tensile tests may be conducted on an INSTRON™ Tensile Tester at a speed of 5 to 50 mm/min. Unless otherwise specified, tensile tests as described herein were conducted on an INSTRON™ Tensile Tester at a speed of 50 mm/min.

### Tensile Elongation

Elongation is measured by applying tensile force or stretching the material and determining change in length from original in the same manner as described above. Elongation is expressed as percentage or original length. Ultimate elongation is the percentage change in length from original to rupture. The material can be tested for tensile elongation, elongation at break according to ASTM D412. In some cases, elongation at break is measured according to ASTM D412 type C standard and test geometry.

In certain examples, suitable materials will have an elongation at break of 400-1,000%, 500-800%, at least 400%, at least 450%, or at least 500%. In some cases, the elongation at break may be at least 550%, at least 600%, or at least 650% of the initial length of the sample.

In some cases, the ASTM D412 or ISO37 methods may be also used for tensile testing of elastomers including cured liquid silicone rubber materials of the present disclosure. ASTM D 412 Method A may be used, e.g., for vulcanized rubber dumbbell shapes. Method B may be used for testing of rubber rings.

### Tensile Modulus

Tensile Modulus of a solid material is a mechanical property that measures its stiffness. It may be defined as the ratio of its tensile stress (force per unit area) to its strain (relative deformation) when undergoing elastic deformation. Modulus may be expressed as the force at a specific elongation value, i.e., 100% or 300% elongation. For example, modulus may be expressed in pounds per square inch (psi) or megapascals (MPa), at 100% elongation or 300%. This is referred to as modulus 100 “M100” or modulus 300 “M300”, respectively. For example, M100 may be selected as a measure of flexibility, and it is calculated as the modulus at 100% strain. M100 may be reported in MegaPascals (MPa).

In some cases, the cold shrink splice appliances according to the present disclosure may exhibit a working temperature range of −55 deg C. to +210 deg C., or at least −40 deg C. to at least +140 deg C.

Hardness may be determined by ASTM D 2240. Unless otherwise specified, ASTM D2240-15 (2021) method may be employed. Unless otherwise specified hardness testing is conducted at room temperature.

The “specific surface area” may be measured by any appropriate method. The specific surface area may be measured by BET method. The BET (Brunauer, Emmet and Teller) theory may be used to evaluate gas adsorption data and generate a specific surface area result expressed in units of area per mass of sample (m²/g).

The term “particle size” or average particle size may be determined by any appropriate method. Particle size may be determined by laser diffraction, sieve analysis, photoanalysis, and the like. The particle size laser diffraction may be determined, for example in a particle size analyzer. The particle size analyzer may be, for example, a CILAS particle size analyzer, such as a CILAS 1064. Particle size distribution (PSD) D₅₀ is known as the median diameter of the particle size distribution. If D₅₀ is 10 micrometers then half of the particles are smaller than 10 micrometers and 50% of the particles are larger than 10 micrometers. If particle size is D₉₀ is 100 micrometers, then 90% of the particles in the tested sample are smaller than 100 micrometers.

The term “thermal conductivity” refers to the rate at which heat penetrates through a given material. Thermal conductivity may be measured as W/(m*K), wherein W=Watts, m=thickness in meters of a sample material, K=temperature difference between a first side of the sample (e.g., to which a thermal energy is applied), and a second side of the sample. The term “high thermal conductivity” refers to a material exhibiting >0.4 W/m*K, >0.5 W/m*K, >0.6 W/m*K. >0.7 W/m*K, 0.8 W/m*K, >1.0 W/m*K, >1.5 W/m*K, or >2.0 W/m*K. In some cases, the thermal conductivity is in a range of 0.3 W/m*K to 2 W/m*K, 0.4 W/m*K to 1.5 W/m*K, or 0.4 W/m*K to 0.8 W/m*K. Thermal conductivity was measured via ISO 22007-2:2015; Plastics—Determination of thermal conductivity and thermal diffusivity—Part 2: Transient plane heat source (hot disc) method. However, thermal conductivity may be measured by any appropriate method, for example, ASTM E1530. The Guarded Heat Flow Method (GHFM-02) follows ASTM E1530-19 for testing thermal conductivity of thin silicone rubber. Thermal conductivity may be measured by ASTM D5470-17. Thermal conductivity may be measured by ASTM E1225.

### Dielectric Tests

The term “dielectric strength” in reference to a dielectric material refers to minimum applied electric field (i.e., the applied voltage divided by electrode separation distance) that results in electrical breakdown. The AC Dielectric Breakdown strength may or “dielectric strength” be determined by ASTM D149 (Standard Test Method for Dielectric Breakdown Voltage and Dielectric Strength of Solid Electrical Insulating Materials at Commercial Power Frequencies). Breakdown strength may be reported as maximum and kV/mm using the median material thickness. The “dielectric constant” (κ) of a material may be determined by ASTM D150 (Standard Test Methods for AC Loss Characteristics and Permittivity (Dielectric Constant) of Solid Electrical Insulation).

The term “volume resistivity” refers to an insulating materials resistance to leakage current through the body of the material. The volume resistivity may be measured by DIN 53482, IEC-62631-3-1, IEC60093, or ASTM D991. The volume resistivity of flat sheet samples may be measured by ASTM D991.

### Compositions

Thermally conductive silicone rubber compositions are provided comprising a silicone rubber and two or more thermally conductive fillers. The thermally conductive fillers may also be electrically insulating fillers. The thermally conductive silicone rubber composition may be a polymerizable composition comprising a two-part liquid silicone rubber, and two or more thermally conductive fillers. The thermally conductive silicone rubber composition may be a cured thermally conductive liquid silicone rubber composition comprising an alumina filler and a boron nitride filler.

The thermally conductive silicone rubber composition may comprise a liquid silicone rubber. The thermally conductive silicone rubber composition may comprise a high consistency silicone rubber. The liquid silicone rubber may be a two-part liquid silicone mixture comprising a cure catalyst. The thermally conductive silicone rubber composition may comprise about 40 to about 80 wt %, about 45 to about 70 wt %, 50 to 65 wt %, or about 50 to about 60 wt %, of the silicone rubber.

The thermally conductive silicone rubber composition of the present disclosure may include two or more thermally conductive filler types such as aluminum oxide, aluminum hydroxide, calcined alumina, boron nitride, aluminum nitride, and the like. The thermally conductive silicone rubber composition may include an aluminum oxide filler and a boron nitride filler. The aluminum oxide filler may be a calcined aluminum oxide filler.

The thermally conductive silicone rubber composition may include two or more, or two thermally conductive fillers in a total thermally conductive filler concentration of about 20 to about 60 wt %, about 30 to about 55 wt %, about 35 to about 50 wt %, or about 40 to about 50 wt %.

Thermally conductive filler types may include various filler sizes of from about 10-600 micrometers. Thermally conductive filler types may include various filler shapes such as agglomerates, platelets, flakes, spherical shapes, and the like. In some cases, the predominant filler shape is selected from platelets and flakes, or a mixture thereof.

The thermally conductive silicone rubber composition may include two or more thermally conductive fillers including an aluminum oxide and/or aluminum hydroxide filler and a boron nitride filler in a total filler concentration of 20 to 60 wt %, 30 to 55 wt %, 35 to 50 wt %, or 40 to 50 wt %.

A thermally conductive silicone rubber composition is provided comprising 40 to 80 wt % of a silicone rubber, and 20 to 60 wt % of combined first and second thermally conductive fillers. A thermally conductive silicone rubber composition is provided comprising 45 to 70 wt of a silicone rubber and 30 to 55 wt % of combined first and second thermally conductive fillers. A thermally conductive silicone rubber composition is provided comprising 50 to 65 wt % of a silicone rubber and 35 to 50 wt % of combined first and second thermally conductive fillers. A thermally conductive silicone rubber composition is provided comprising 40 to 80 wt % of a liquid silicone rubber, and 20 to 60 wt % of combined first and second thermally conductive fillers. A thermally conductive silicone rubber composition is provided comprising 45 to 70 wt of a liquid silicone rubber and 30 to 55 wt % of combined first and second thermally conductive fillers. A thermally conductive silicone rubber composition is provided comprising 50 to 65 wt % of a liquid silicone rubber and 35 to 50 wt % of combined first and second thermally conductive fillers.

The thermally conductive silicone rubber composition may include two or more thermally conductive fillers including an aluminum oxide and/or aluminum hydroxide filler and a boron nitride filler in an aluminum oxide:boron nitride ratio of 1:1 to 6:1, 2:1 to 5.5:1, or 2:1 to 5.25:1, or 3:1 to 5:1.

Thermally conductive silicone rubber compositions are provided comprising a ratio of 2:1 to 5.25:1 aluminum oxide/boron nitride filler and 35-50 wt % total combined thermally conductive filler.

The thermally conductive silicone rubber composition may further comprise one of more additives selected from the group consisting of dyes, pigments, additional fillers, dispersants, and flame retardants.

The cured thermally conductive silicone rubber composition may exhibit a thermal conductivity of >0.3 W/m*K, >0.4 W/m*K, >0.5 W/m*K, >0.6 W/m*K, or >0.7 W/m*K by ISO 22007-2:2015 and an elongation at break of 400-1,000%, 500-800%, at least 400%, at least 450%, at least 500%, at least 550%, or at least 600% by ASTM D412-2021 type V. The cured thermally conductive silicone rubber composition may further exhibit one or more, two or more, or three or more of the following properties: M300 modulus in a range of 0.9 to 5 MPa, 1.0-4 MPa, or >1.1 MPa; tensile strength in a range of 1.80 to 7.8 MPa, >3.0 MPa, or >3.5 MPa; dielectric constant of >2.5, >3.0, or >3.5; and dielectric strength of >14 kV/mm, >15 kV/mm, >16 kV/mm, >17 kV/mm, or >18 kV/mm. The tensile strength may be determined by ASTM D412-2021 type V. The modulus may be determined by ASTM D412-2021 type V. The dielectric constant may be measured by ASTM D150. The dielectric strength may be measured by ASTM D149.

Thermally conductive silicone rubber compositions are provided that exhibit one or more or two or more desirable thermal and physical properties after curing including thermal conductivity of >0.3 W/m*K, >0.4 W/m*K, or >0.5 W/m*K, >0.6 W/m*K, or >0.7 W/m*K, or 0.4-2 W/m*K, 0.4-1.5 W/m*K, 0.4-1 W/m*K, 0.4-0.8 W/m*K: M300 modulus on a range of 0.9 to 2.5 MPa, or >1.1 MPa; tensile strength in a range of 1.80 to 7.8 MPa, >3.0 MPa, or >3.5 MPa, and elongation at break in a range of 400-1,000%, 500-1,000%, 500% to 800%, >500%, >550%, or >600%.

### EXAMPLES

### Example I. Thermally Conductive Liquid Silicone Rubber Compositions

Liquid silicone rubber formulations were prepared using 1:1 parts A and B of either Silopren® LSR 2030 (Momentive Performance Materials, Inc., “LSR 2030”), XIAMETER® RBL-2004-20 liquid silicone rubber (DOW Chemical Company, “RBL 2004”), or ELASTOSIL® LR 5040/20 US A/B (Wacker Chemie AG, “ELR 5040”). Thermally conductive fillers were added to the LSR according to Table 1, and the formulations were mixed by either Hobart and Brabender (H+B) double planetary mixer or Centrifugal mixer with vacuum (C+V) to obtain a homogenous composition.

TABLE 1
Thermally Conductive Liquid Silicone Rubber Compositions

| | | Filler 1 | | | Filler 1 | Filler 2 | | LSR |
|---|---|---|---|---|---|---|---|---|
| | Mixing | type Al₂O₃ | Filler 2 | LSR | Cont. | Cont. | Total | Content |
| Example | method | or Al(OH)₃ | type BN | Type | wt. % | wt. % | filler % | wt. % |
| 1 | H + B | 4220.00 | NA | LSR 2030 | 20.00 | 0.00 | 20.00 | 80.00 |
| 2 | H + B | 4220.00 | NA | LSR 2030 | 30.00 | 0.00 | 30.00 | 70.00 |
| 3 | C + V | 2590.00 | NA | LSR 2030 | 35.00 | 0.00 | 35.00 | 65.00 |
| 4 | C + V | 3810.00 | NA | LSR 2030 | 35.00 | 0.00 | 35.00 | 65.00 |
| 5 | H + B | NA | NA | RBL-2004 | 0.00 | 0.00 | 0.00 | 100.00 |
| 6 | H + B | 3220.00 | 30D | RBL-2004 | 25.00 | 10.00 | 35.00 | 65.00 |
| 7 | H + B | 3220.00 | 200-3 | RBL-2004 | 25.00 | 10.00 | 35.00 | 65.00 |
| 8 | H + B | 3220.00 | 75.00 | RBL-2004 | 25.00 | 10.00 | 35.00 | 65.00 |
| 9 | H + B | 3220.00 | 30D | LSR 2030 | 25.00 | 10.00 | 35.00 | 66.00 |
| 10 | H + B | 3220.00 | CFA50M | LSR 2030 | 25.00 | 10.00 | 35.00 | 67.00 |
| 11 | H + B | 3220.00 | 75.00 | LSR 2030 | 25.00 | 10.00 | 35.00 | 68.00 |
| 12 | C + V | 3220.00 | 30D | LSR 2030 | 25.00 | 10.00 | 35.00 | 65.00 |
| 13 | C + V | 3220.00 | 200-3 | LSR 2030 | 25.00 | 10.00 | 35.00 | 65.00 |
| 14 | C + V | 3220.00 | 75.00 | LSR 2030 | 25.00 | 10.00 | 35.00 | 65.00 |
| 33 | C + V | 3220.00 | 75.00 | LSR 2030 | 40.00 | 0 | 40.00 | 60.00 |
| 34 | C + V | 3220.00 | 75.00 | LSR 2030 | 0 | 10.00 | 10.00 | 90.00 |
| 35 | C + V | 3220.00 | 75.00 | LSR 2030 | 8.00 | 12.00 | 20.00 | 80.00 |
| 36 | C + V | 3220.00 | 75.00 | LSR 2030 | 20.00 | 8.00 | 28.00 | 72.00 |
| 37 | C + V | 3220.00 | 75.00 | ELR 5040 | 40.00 | 10.00 | 50.00 | 50.00 |
| 38 | C + V | 3220.00 | 75.00 | RBL 2004 | 40.00 | 10.00 | 50.00 | 50.00 |
| 39 | C + V | 3220.00 | MP05 | LSR 2030 | 40.00 | 10.00 | 50.00 | 50.00 |
| 40 | C + V | 3220.00 | SP16 | LSR 2030 | 40.00 | 10.00 | 50.00 | 50.00 |
| 41 | C + V | 3220.00 | MP20 | LSR 2030 | 40.00 | 10.00 | 50.00 | 50.00 |
| 42 | C + V | HC500 | 75.00 | LSR 2030 | 40.00 | 10.00 | 50.00 | 50.00 |
| 43 | C + V | HC170 | 75.00 | LSR 2030 | 40.00 | 10.00 | 50.00 | 50.00 |

In Table 1, conductive fillers are as follows. 4220 is MARTOXID™ TM-4220 calcined alumina (Al₂O₃), Huber Advanced Materials. 3220 is MARTOXID™ TM-3220 calcined alumina (Al₂O₃), Huber Advanced Materials. 2590 is MARTINAL® TM-2590 aluminum hydroxide (Al(OH)₃), Huber Advanced Materials. 3810 is MARTINAL® TM-3810 aluminum hydroxide Al(OH)₃, Huber Advanced Materials. 30D is boron nitride flowable platelets FP30 Saint-Gobain surface area 1.2 m²/g., D₅₀ ˜400 micrometers. 200-3 is boron nitride flakes, 3M Company. 75.00 is boron nitride filler platelets 0075, D (0.9) 12-25 micrometers, surface area <10 m²/g, 3M Company. CFA50M is boron nitride mix of platelets, flakes and agglomerates, 3M Company. MP20 is boron nitride modified platelets having D₅₀ of ˜5.4 micrometers and D₉₀ ˜20 micrometers, Saint-Gobain. MP20 is made of submicron BN crystals with higher oxygen O₂ levels ˜1.7%. MP05 is boron nitride modified platelets having D₅₀ of ˜10 micrometers and D₉₀ of ˜20 micrometers, Saint-Gobain. MP05 is a higher density, slightly agglomerated particles of high purity platelets having ˜0.7% O₂. SP16 is boron nitride standard platelets having D₅₀ of ˜16 micrometers and D₉₀ of ˜50 micrometers, Saint-Gobain. SP16 comprise high purity single crystals of BN with little to no agglomeration having ˜0.6% O₂. HC500 is APYRAL® HC 500 aluminum hydroxide Al(OH)₃. Nabaltec AG, having a D₅₀ of ˜30 micrometers and a D₉₀ of ˜110 micrometers. HC170 is NABALOX® HC170 aluminum oxide Al₂O₃ having D₅₀ of ˜4 micrometers and a D₉₀ of ˜15 micrometers.

The mixed compositions were injected to a heated mold and cured according to methods described in the disclosure. The samples were then tested for various physical and thermal characteristics. Results are shown in Table 2.

TABLE 2
Thermally Conductive Liquid Silicone Rubber Properties

| | | | Tensile | | Elongation | | TC | |
|---|---|---|---|---|---|---|---|---|
| | Modulus | | strength | | @ | | Bulk | |
| | (MPa) | Stdev | (MPa) | Stdev2 | break (%) | Stdev3 | (W/mK) | stdev |
| | | | | | | | Thermal Test | |
| Example | Mechanical Test Results | | | | | | Results | |
| 1 | 1.57 | 0.18 | 7.71 | 0.64 | 538.40 | 28.84 | 0.263 | NA |
| 2 | 1.27 | 0.11 | 5.03 | 0.33 | 261.90 | 25.80 | 0.310 | NA |
| 3 | 0.98 | 0.04 | 4.06 | 0.58 | 739.00 | 31.06 | 0.322 | NA |
| 4 | 1.03 | 0.02 | 3.70 | 0.30 | 703.00 | 15.42 | 0.356 | NA |
| 5 | 1.30 | 84.00 | 5.20 | 78.00 | 768.00 | 41.30 | 0.20 | NA |
| 6 | 1.00 | 3.60 | 1.80 | 15.30 | 478.00 | 25.80 | 0.473 | NA |
| 7 | 1.10 | 5.80 | 2.70 | 8.30 | 622.00 | 11.60 | 0.473 | NA |
| 8 | 1.30 | 3.70 | 3.00 | 59.70 | 648.00 | 57.00 | 0.442 | NA |
| 9 | 0.90 | NA | 4.50 | NA | 681.00 | NA | 0.466 | NA |
| 10 | 0.90 | NA | 2.90 | NA | 581.00 | NA | 0.477 | NA |
| 11 | 1.00 | NA | 5.50 | NA | 719.00 | NA | 0.452 | NA |
| 12 | 2.46 | 0.70 | 2.32 | 0.37 | 530.00 | 54.45 | 0.425 | 0.009 |
| 13 | 1.40 | 0.01 | 3.37 | 0.48 | 604.00 | 42.75 | 0.466 | 0.005 |
| 14 | 1.71 | 0.02 | 5.60 | 0.25 | 723.00 | 12.66 | 0.472 | 0.012 |
| 33 | 1.633 | 0.067 | 6.180 | 0.490 | 680.500 | 4.500 | 0.350 | NA |
| 34 | 2.049 | 0.150 | 9.140 | 0.429 | 731.000 | 48.000 | 0.300 | NA |
| 35 | 2.170 | 0.015 | 4.550 | 0.298 | 627.429 | 23.347 | 0.320 | NA |
| 36 | 1.967 | 0.022 | 7.072 | 0.467 | 735.000 | 17.445 | 0.310 | NA |
| 37 | 2.120 | 0.020 | 2.842 | 0.197 | 461.800 | 32.760 | 0.622 | NA |
| 38 | 1.208 | 0.022 | 2.958 | 0.071 | 698.250 | 12.194 | 0.687 | NA |
| 39 | 1.861 | 0.036 | 6.423 | 0.443 | 717.800 | 20.951 | 0.720 | NA |
| 40 | 1.649 | 0.012 | 4.038 | 0.193 | 645.750 | 15.466 | 0.690 | NA |
| 41 | 1.822 | 0.022 | 3.923 | 0.257 | 615.143 | 28.053 | 0.490 | NA |
| 42 | NA | NA | NA | NA | NA | NA | 0.693 | NA |
| 43 | NA | NA | NA | NA | NA | NA | 0.605 | NA |

NA = not available

Liquid silicone rubber without thermally conductive filler (example 5) exhibited undesirable low thermal conductivity of 0.20 W/mK, as shown in Table 2. Examples 1-4 and 33, using Al₂O₃ filler only (20-40 wt %) without boron nitride exhibited somewhat increased thermal conductivity that ranged from 0.263 to 0.356 W/mK with only some samples exhibiting acceptable elongation at break. Example 34, using only boron nitride TC filler (10 wt %), without Al₂O₃ or Al(OH)₃ filler, exhibited a thermal conductivity of 0.300 W/mK. Examples 35 and 36 using 20-28 wt % total TC filler and a mix of Al₂O₃ and boron nitride TC fillers exhibited a thermal conductivity of 0.310 to 0.320 W/mK with acceptable elongation at break. Example 6-14 using 35% total TC filler and a ratio of Al₂O₃ or Al(OH)₃ to BN or 2.5:1 exhibited desirable increased thermal conductivity that ranged from 0.425 to 0.477 W/mK. Examples 35 and 36 each exhibited a hardness value of 41 Shore A. Examples 39, 40 and 41 exhibited hardness values of 53, 53, and 47 Shore A, respectively, under ASTM D2240 at room temperature.

Thermally conductive liquid silicone rubber compositions including a combination of an LSR including both a thermally conductive alumina filler (either calcined alumina, aluminum oxide, or aluminum hydroxide) and a boron nitride with centrifugal mixing exhibited desirable thermal conductivity (TC) of >0.4 W/m*k and elongation at break of >400%. Based on preliminary results in Table 2, a thermally conductive LSR compositions were developed using a combination of aluminum oxide (calcined alumina) and boron nitride fillers.

### Example II. Thermally Conductive Liquid Silicone Rubber Compositions with Various Ratios of Aluminum Oxide (Calcined Alumina) and Boron Nitride Fillers

Liquid silicone rubber formulations were prepared using 1:1 parts A and B of Silopren® LSR 2030 (Momentive Performance Materials, Inc.). Thermally conductive fillers were added to the LSR according to Table 3, and the formulations were mixed by a Centrifugal mixer with vacuum (C+V), a (D+M) double planetary mixer, or a vertical shaft mixer (V+S) to obtain a homogenous composition. Thermally conductive filler 1 “3220” calcined alumina (Al₂O₃), MARTOXID™ TM-3220, Huber Advanced Materials, and thermally conductive filler 2 “75” boron nitride filler platelets 0075, D (0.9) 12-25 micrometers, surface area <10 m²/g, 3M Company were employed.

TABLE 3
Thermally Conductive Liquid Silicone Rubber Compositions

| | | Filler 1 | Filler 2 | Ratio | | |
|---|---|---|---|---|---|---|
| example | Mixing | wt % | wt % | fill- | Total | LSR |
| # | method | Al₂O₃ | BN | er1:filler 2 | filler % | wt. % |
| 15a* | C + V | 0.00 | 0.00 | na | 0.00 | 100.00 |
| 15b** | C + V | 0.00 | 0.00 | na | 0.00 | 100.00 |
| 16 | C + V | 40.00 | 10.00 | 4:1 | 50.00 | 50.00 |
| 17 | C + V | 36.00 | 8.00 | 4.5:1 | 44.00 | 56.00 |
| 18 | C + V | 30.00 | 11.50 | 3.1:1 | 41.50 | 58.50 |
| 19 | C + V | 32.50 | 15.00 | 2.2:1 | 47.50 | 52.50 |
| 20 | C + V | 38.50 | 11.50 | 3.3:1 | 50.00 | 50.00 |
| 21 | C + V | 35.00 | 15.00 | 2.3:1 | 50.00 | 50.00 |
| 22 | C + V | 34.63 | 13.25 | 2.6:1 | 47.88 | 52.13 |
| 23 | C + V | 30.00 | 15.00 | 2:1 | 45.00 | 55.00 |
| 24 | C + V | 38.13 | 9.75 | 3.9:1 | 47.88 | 52.13 |
| 25 | C + V | 34.25 | 11.50 | 3:1 | 45.75 | 54.25 |
| 26 | C + V | 42.00 | 8.00 | 5.25:1 | 50.00 | 50.00 |
| 27 | C + V | 32.13 | 9.75 | 3.3:1 | 41.88 | 58.13 |
| 28 | C + V | 32.13 | 13.25 | 2.4:1 | 45.38 | 54.63 |
| 29 | C + V | 30.00 | 8.00 | 3.75:1 | 38.00 | 62.00 |
| 30 | C + V | 25.00 | 10.00 | 2.5:1 | 35.00 | 65.00 |
| 31 | C + V | 35.00 | 10.00 | 3.5:1 | 45.00 | 55.00 |
| 32 | C + V | 33.00 | 12.00 | 2.75:1 | 45.00 | 55.00 |
| 44 | D + M | 40.00 | 10.00 | 4:1 | 50.00 | 50.00 |
| 45 | D + M | 40.00 | 10.00 | 4:1 | 50.00 | 50.00 |
| 46 | V + S | 40.00 | 10.00 | 4:1 | 50.00 | 50.00 |
| 47 | D + M | 40.00 | 10.00 | 4:1 | 50.00 | 50.00 |
| 48 | D + M | 40.00 | 10.00 | 4:1 | 50.00 | 50.00 |
| 49 | D + M | 40.00 | 10.00 | 4:1 | 50.00 | 50.00 |

*processed and tested in house,
**processed and tested by LSR manufacturer

The mixed compositions were injected to a heated mold and cured according to the disclosure. Mechanical test specimens were prepared in adherence to ASTM D412 Type 5 dumbbells. Thermal conductivity was measured on 1.5×1.5″ square slabs ranging from 1-2 mm thick. The samples were then tested for various physical and thermal characteristics. Results are shown in Table 4 and 5, respectively.

TABLE 4
Mechanical Properties Thermally Conductive LSR Compositions

| | | | | | | |
|---|---|---|---|---|---|---|
| | | | Tensile | | Elongation | |
| example | Modulus | | strength | | @ | |
| # | (MPa) | Stdev | (MPa) | Stdev2 | break (%) | Stdev3 |

Mechanical Test Results

| | | | | | | |
|---|---|---|---|---|---|---|
| 15a* | 1.71 | 0.02 | 5.60 | 0.25 | 723.00 | 12.66 |
| 15b** | 1.28 | 0.02 | 6.41 | 0.68 | 800.00 | 29.32 |
| 16 | 1.76 | 0.03 | 4.30 | 0.21 | 664.00 | 19.00 |
| 17 | 1.69 | 0.02 | 4.82 | 0.22 | 670.00 | 19.00 |
| 18 | 1.18 | 0.03 | 4.18 | 0.52 | 614.00 | 37.00 |
| 19 | 1.92 | 0.01 | 3.72 | 0.41 | 584.00 | 42.00 |
| 20 | 1.82 | 0.01 | 3.67 | 0.19 | 587.00 | 15.00 |
| 21 | 1.94 | 0.02 | 3.72 | 0.68 | 577.00 | 78.00 |
| 22 | 1.87 | 0.01 | 3.87 | 0.79 | 581.00 | 74.00 |
| 23 | 1.91 | 0.02 | 4.56 | 0.29 | 643.00 | 24.00 |
| 24 | 1.72 | 0.02 | 4.36 | 0.16 | 650.00 | 7.79 |
| 25 | 1.85 | 0.02 | 3.91 | 0.71 | 586.00 | 72.00 |
| 26 | 1.63 | 0.03 | 3.54 | 0.44 | 586.00 | 39.00 |
| 27 | 1.81 | 0.02 | 4.52 | 0.89 | 629.00 | 66.00 |
| 28 | 1.91 | 0.02 | 4.02 | 0.57 | 593.00 | 48.00 |
| 29 | 1.68 | 0.02 | 5.22 | 0.24 | 678.00 | 6.00 |
| 30 | 1.71 | 0.02 | 5.60 | 0.25 | 723.00 | 12.66 |
| 31 | 1.91 | 0.04 | 5.43 | 0.21 | 646.27 | 12.36 |
| 32 | 1.89 | 0.03 | 4.64 | 0.72 | 592.81 | 60.08 |
| 44 | 1.878 | 0.031 | 3.807 | 0.518 | 629.170 | 44.350 |
| 45 | 1.839 | 0.023 | 3.912 | 0.499 | 622.914 | 47.925 |
| 46 | 1.694 | 0.018 | 4.371 | 0.157 | 666.200 | 11.370 |
| 47 | 1.700 | 0.012 | 4.255 | 0.227 | 678.900 | 19.270 |
| 48 | 1.723 | 0.009 | 4.690 | 0.058 | 696.150 | 6.087 |
| 49 | 1.713 | 0.037 | 4.147 | 0.092 | 662.230 | 19.440 |

*tested in house,
**tested by LSR manufacturer

TABLE 5
Thermal Properties Thermally Conductive LSR Compositions

| | | | | | |
|---|---|---|---|---|---|
| | TC In | TC In | TC In | | |
| | plane | plane | plane | TC | TC |
| example | Left | Center | Right | Bulk | Standard |
| # | (W/mK) | (W/mK) | (W/mK) | (W/mK) | deviation |

Thermal Test Results

| | | | | | |
|---|---|---|---|---|---|
| 15a* | nt | nt | nt | 0.200 | |
| 15b** | nt | nt | nt | 0.200 | |
| 16 | 0.638 | 0.638 | 0.661 | 0.646 | 0.011 |
| 17 | 0.515 | 0.518 | 0.509 | 0.514 | 0.004 |
| 18 | 0.5490 | 0.553 | 0.555 | 0.554 | 0.001 |
| 19 | 0.704 | 0.703 | 0.698 | 0.702 | 0.003 |
| 20 | 0.679 | 0.681 | 0.682 | 0.681 | 0.001 |
| 21 | 0.693 | 0.696 | 0.693 | 0.694 | 0.001 |
| 22 | 0.657 | 0.675 | 0.658 | 0.663 | 0.008 |
| 23 | 0.678 | 0.662 | 0.671 | 0.670 | 0.007 |
| 24 | 0.639 | 0.618 | 0.621 | 0.626 | 0.009 |
| 25 | 0.626 | 0.623 | 0.627 | 0.625 | 0.002 |
| 26 | 0.582 | 0.582 | 0.589 | 0.584 | 0.003 |
| 27 | 0.567 | 0.549 | 0.559 | 0.558 | 0.007 |
| 28 | 0.694 | 0.695 | 0.696 | 0.695 | 0.001 |
| 29 | 0.451 | 0.449 | 0.449 | 0.450 | 0.001 |
| 30 | 0.480 | 0.481 | 0.455 | 0.472 | 0.012 |
| 31 | 0.598 | 0.618 | 0.594 | 0.603 | 0.010 |
| 32 | 0.617 | 0.610 | 0.592 | 0.606 | 0.011 |
| 44 | nt | nt | nt | 0.665 | 0.003 |
| 45 | nt | nt | nt | 0.639 | 0.003 |
| 46 | nt | nt | nt | 0.580 | 0.001759 |
| 47 | nt | nt | nt | 0.650 | 0.003335 |
| 48 | nt | nt | nt | 0.660 | 0.007292 |
| 49 | nt | nt | nt | 0.650 | 0.000653 |

Note:
thermal properties measurement has standard error of ±5%;
*tested in house,
**tested by LSR manufacturer,
nt = not tested

As shown in Table 4, LSR compositions including a ratio of 2:1 to 5.25:1 aluminum oxide/boron nitride filler and about 35 to about 50 wt % total TC filler exhibited desirable physical properties including M300 modulus that ranged from 1.18-1.94 MPa, tensile strength that ranged from 3.54 to 5.60 MPa, and elongation at break that ranged from 577-723%.

As shown in Table 5, LSR compositions including a ratio of 2:1 to 5.25:1 aluminum oxide/boron nitride filler and 35-50 wt % total TC filler exhibited desirable thermal conductivity of >0.4 W/m*K. LSR compositions including a ratio of 2:1 to 5.25:1 aluminum oxide/boron nitride filler compositions and about 40 to about 50 wt % total TC filler exhibited desirable thermal conductivity of >0.5 W/m*K.

### Example III. Thermally Conductive Liquid Silicone Rubber Compositions Dielectric Constant and Breakdown Strength

In this example, a 9″×9″ square molded slab of thermally conductive liquid silicone rubber material according to example 16 was provided for testing. Median thickness was measured as 2.051 mm by ASTM D3767.

Test Methods: ASTM D₁₄₉ (Standard Test Method for Dielectric Breakdown Voltage and Dielectric Strength of Solid Electrical Insulating Materials at Commercial Power Frequencies) and ASTM D150 (Standard Test Methods for AC Loss Characteristics and Permittivity (Dielectric Constant) of Solid Electrical Insulation). Dielectric properties are shown in Table 6.

TABLE 6
Dielectric Properties Thermally Conductive LSR Compositions

| Test | Replicate | Replicate | Replicate | Replicate | | |
|---|---|---|---|---|---|---|
| TC LSR | 1 | 2 | 3 | 4 | Average | Median |
| Thickness | 2.051 | 2.072 | 2.051 | 2.029 | 2.051 | 2.051 |
| (mm) | | | | | | |
| Dielectric | 3.685 | 3.718 | 3.657 | 3.648 | 3.677 | 3.671 |
| Constant | | | | | | |
| Breakdown | 39.7 | 39.5 | 41.1 | 39.7 | 40.0 | 39.7 |
| Voltage (kV) | | | | | | |
| Max. Amps | 4.48 | 10.45 | 1.59 | 1.51 | 4.5 | 3.0 |
| (mA) | | | | | | |
| kV/mm | 19.4 | 19.3 | 20.0 | 19.4 | 19.5 | 19.4 |

Results: Median dielectric constant was 3.671. Median dielectric breakdown strength was 39.7 kV or 19.4 kV/mm.

The embodiments described in one aspect of the present disclosure are not limited to the aspect described. The embodiments may also be applied to a different aspect of the disclosure as long as the embodiments do not prevent these aspects of the disclosure from operating for its intended purpose.

### CLAUSES

Clause 1. A shaped, stretched, and cured splice article comprising
an innermost layer comprising an electrically conductive silicone rubber composition; and
a second layer immediately adjacent to the innermost layer, the second layer comprising a thermally conductive silicone rubber composition comprising:
   a silicone rubber;
   a first thermally conductive filler; and
   a second thermally conductive filler.

Clause 2. The article of clause 1, wherein the splice article is a cold shrink splice article.

Clause 3. The article of clause 1 or 2, wherein the silicone rubber is selected from the group consisting of a liquid silicone rubber and a high consistency silicone rubber.

Clause 4. The article of clause 3, wherein the liquid silicone rubber is a two-part liquid silicone mixture comprising a cure catalyst.

Clause 5. The article of any one of clauses 1 to 4, wherein the first and second thermally conductive fillers are selected from the group consisting of aluminum oxide, aluminum hydroxide, fumed alumina, aluminum nitride, and boron nitride.

Clause 6. The article of any one of clauses 1 to 5, wherein the first thermally conductive filler is selected from the group consisting of aluminum oxide (Al₂O₃) and aluminum hydroxide (Al(OH)₃), optionally wherein the aluminum oxide is calcined aluminum oxide comprising >95%, >97%, or >98% Al₂O₃.

Clause 7. The article of any one of clauses 1 to 6, wherein the first thermally conductive filler has a particle size distribution D₉₀ in a range of 3-150 micrometers, 3-120 micrometers, 3-100 micrometers, 4-80 micrometers, or 15-50 micrometers.

Clause 8. The article of any one of clauses 1 to 7, wherein the first thermally conductive filler has a predominant particle shape selected from the group consisting of platelets and flakes.

Clause 9. The article of any one of clauses 1 to 8, wherein the second thermally conductive filler is a boron nitride filler.

Clause 10. The article of any one of clauses 1 to 9, wherein the second thermally conductive filler has a particle size distribution D₉₀ in a range of 10-800 micrometers, 10-500 micrometers, 10-100 micrometers, or 12-50 micrometers.

Clause 11. The article of any one of clauses 1 to 10, wherein the second thermally conductive filler has a predominant particle shape consisting of platelets, flakes, or a mixture thereof.

Clause 12. The article of any one of clauses 1 to 11, comprising 20 to 60 wt %, 30 to 55 wt %, 35 to 50 wt %, or 40 to 50 wt % of combined first and second thermally conductive fillers.

Clause 13. The article of any one of clauses 1 to 12, wherein the weight ratio of the first conductive filler to the second conductive filler is in a ratio of 1:1 to 6:1, 2:1 to 5.5:1, 2:1 to 5.25:1, or 3:1 to 5:1.

Clause 14. The article of any one of clauses 1 to 13, wherein the thermally conductive silicone rubber composition comprises 40-80 wt %, 45-70 wt %, 50-65 wt %, or 50-60 wt % of the silicone rubber.

Clause 15. The article of any one of clauses 1 to 14, further comprising one of more additives selected from the group consisting of dyes, pigments, additional fillers, dispersants, and flame retardants.

Clause 16. The article of any one of clauses 1 to 15, wherein the cured thermally conductive silicone rubber composition exhibits one or more of
a thermal conductivity of >0.3 W/m*K, >0.4 W/m*K, >0.5 W/m*K, >0.6 W/m*K, or >0.7 W/m*K;
an elongation at break of 400-1,000%, 500-1,000%, 500-800%, at least 500%, at least 550%, or at least 600%; optionally wherein the composition further exhibits
M300 modulus in a range of 0.9 to 5 MPa, 1.0-4 MPa, or >1.1 MPa;
tensile strength in a range of 1.80 to 7.8 MPa, >3.0 MPa, or >3.5 MPa;
hardness in a range of 30 to 60 Shore A, 35 to 55 Shore A, or 40 to 50 Shore A;
dielectric constant of >2.5, >3.0, or >3.5; and
dielectric strength of >14 kV/mm, >15 kV/mm, >16 kV/mm, >17 kV/mm, or >18 kV/mm.

Clause 17. The article of any one of clauses 1 to 16, comprising at least three layers including
an innermost layer comprising an electrically conductive silicone rubber composition;
an intermediate layer comprising the thermally conductive silicone rubber composition; and
an outer or outermost layer comprising an electrically conductive silicone rubber composition.

Clause 18. The article of clause 17, wherein the innermost electrically conductive liquid silicone rubber layer and outer or outermost electrically conductive liquid silicone rubber layer each independently exhibit a volume resistivity in a range of no more than 300 ohm cm, 5 ohm cm to 300 ohm cm, 10 ohm cm to 200 ohm cm, 20 ohm cm to 100 ohm cm, or <300 ohm cm, <200 ohm cm, <100 ohm cm, <75 ohm cm, or <50 ohm cm.

Clause 19. A method of making the splice article of any one of clauses 1 to 18, the method comprising
(i) obtaining the electrically conductive silicone rubber composition;
(ii) formulating the thermally conductive silicone rubber composition comprising the silicone rubber, the first thermally conductive filler, and the second thermally conductive filler as a homogenous composition;
(iii) forming the electrically conductive silicone rubber composition and the homogenous thermally conductive silicone rubber composition into a shaped article;
(iv) at least partially curing the shaped article;
(v) stretching the cured shaped article; and
(vi) maintaining the stretched, cured article in a stretched state.

Clause 20. The method of clause 19, wherein the forming comprises
molding together
a first inner layer comprising the electrically conductive silicone rubber composition; and
a second layer comprising the homogenous silicone rubber composition.

Clause 21. The method of clause 19 or 20, wherein the forming further comprises
molding together the first and second layers with a third outer or outermost layer comprising an electrically conductive silicone rubber composition.

Clause 22. A thermally conductive silicone rubber composition comprising:
a silicone rubber;
a first thermally conductive filler; and
a second thermally conductive filler.

Clause 23. The composition of clause 22, wherein the silicone rubber is selected from the group consisting of liquid silicone rubber and a high consistency silicone rubber.

Clause 24. The composition of clause 22 or 23, wherein the liquid silicone rubber is a two-part liquid silicone mixture comprising a cure catalyst.

Clause 25. The composition of any one of clauses 22 to 24, wherein the first and second thermally conductive fillers are selected from the group consisting of aluminum oxide, aluminum hydroxide, fumed alumina, aluminum nitride, and boron nitride.

Clause 26. The composition of any one of clauses 22 to 25, wherein the first thermally conductive filler is selected from the group consisting of aluminum oxide (Al₂O₃) and aluminum hydroxide (Al(OH)₃), optionally wherein the aluminum oxide is calcined aluminum oxide comprising >95%, >97%, or >98% Al₂O₃.

Clause 27. The composition of any one of clauses 22 to 26, wherein the first thermally conductive filler has a particle size distribution D₉₀ in a range of 3-150 micrometers, 3-120 micrometers, 3-100 micrometers, 4-80 micrometers, or 15-50 micrometers.

Clause 28. The composition of any one of clauses 22 to 27, wherein the first thermally conductive filler has a predominant particle shape selected from the group consisting of platelets and flakes.

Clause 29. The composition of any one of clauses 22 to 28, wherein the second thermally conductive filler is a boron nitride filler.

Clause 30. The composition of any one of clauses 22 to 29, wherein the second thermally conductive filler has a particle size distribution D₉₀ in a range of 10-800 micrometers, 10-500 micrometers, 10-100 micrometers, or 12-50 micrometers.

Clause 31. The composition of any one of clauses 22 to 30, wherein the second thermally conductive filler has a predominant particle shape selected from the group consisting of platelets and flakes, or a mixture thereof.

Clause 32. The composition of any one of clauses 22 to 31, comprising 20 to 60 wt %, 30 to 55 wt %, 35 to 50 wt %, or 40 to 50 wt % of combined first and second thermally conductive fillers.

Clause 33. The composition of any one of clauses 22 to 32, wherein the weight ratio of the first conductive filler to the second conductive filler is in a ratio of 1:1 to 6:1, 2:1 to 5.5:1, 2:1 to 5.25:1, or 3:1 to 5:1.

Clause 34. The composition of any one of clauses 22 to 33, wherein the thermally conductive silicone rubber composition comprises 40-80 wt %, 45-70 wt %, 50-65 wt %, or 50-60 wt % of the silicone rubber.

Clause 35. The composition of any one of clauses 22 to 34, further comprising one of more additives selected from the group consisting of dyes, pigments, additional fillers, dispersants, and flame retardants.

Clause 36. The composition of any one of clauses 22 to 35, wherein the cured composition exhibits
a thermal conductivity of >0.3 W/m*K, >0.4 W/m*K, >0.5 W/m*K, >0.6 W/m*K, or >0.7 W/m*K;
an elongation at break of 400-1,000%, 500-1,000%, 500-800%, at least 500%, at least 550%, or at least 600%; optionally wherein the composition further exhibits
M300 modulus in a range of 0.9 to 5 MPa, 1.0-4 MPa, or >1.1 MPa;
tensile strength in a range of 1.80 to 7.8 MPa, >3.0 MPa, or >3.5 MPa;
hardness in a range of 30 to 60 Shore A, 35 to 55 Shore A, or 40 to 50 Shore A;
dielectric constant of >2.5, >3.0, or >3.5; and
dielectric strength of >14 kV/mm, >15 kV/mm, >16 kV/mm, >17 kV/mm, or >18 kV/mm.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A shaped, stretched, and cured splice article comprising
an innermost layer comprising an electrically conductive silicone rubber composition; and
a second layer immediately adjacent to the innermost layer, the second layer comprising a thermally conductive silicone rubber composition comprising:
a silicone rubber;
a first thermally conductive filler; and
a second thermally conductive filler.

2. The article of claim 1, wherein the splice article is a cold shrink splice article.

3. The article of claim 1, wherein the silicone rubber is selected from the group consisting of a liquid silicone rubber and a high consistency silicone rubber.

4. The article of claim 3, wherein the liquid silicone rubber is a two-part liquid silicone mixture comprising a cure catalyst.

5. The article of claim 1, wherein the first and second thermally conductive fillers are selected from the group consisting of aluminum oxide, aluminum hydroxide, fumed alumina, aluminum nitride, and boron nitride.

6. The article of claim 5, wherein the first thermally conductive filler is selected from the group consisting of aluminum oxide (Al₂O₃) and aluminum hydroxide (Al(OH)₃), optionally wherein the aluminum oxide is calcined aluminum oxide comprising >95%, >97%, or >98% Al₂O₃.

7. The article of claim 6, wherein the first thermally conductive filler has a particle size distribution D₉₀ in a range of 3-150 micrometers, 3-120 micrometers, 3-100 micrometers, 4-80 micrometers, or 15-50 micrometers.

8. The article of claim 7, wherein the first thermally conductive filler has a predominant particle shape selected from the group consisting of platelets and flakes.

9. The article of claim 5, wherein the second thermally conductive filler is a boron nitride filler.

10. The article of claim 9, wherein the second thermally conductive filler has a particle size distribution D₉₀ in a range of 10-800 micrometers, 10-500 micrometers, 10-100 micrometers, or 12-50 micrometers.

11. The article of claim 10, wherein the second thermally conductive filler has a predominant particle shape consisting of platelets, flakes, or a mixture thereof.

12. The article of claim 1, comprising 20 to 60 wt %, 30 to 55 wt %, 35 to 50 wt %, or 40 to 50 wt % of combined first and second thermally conductive fillers.

13. The article of claim 1, wherein the weight ratio of the first conductive filler to the second conductive filler is in a ratio of 1:1 to 6:1, 2:1 to 5.5:1, 2:1 to 5.25:1, or 3:1 to 5:1.

14. The article of claim 1, wherein the thermally conductive silicone rubber composition comprises 40-80 wt %, 45-70 wt %, 50-65 wt %, or 50-60 wt % of the silicone rubber.

15. The article of claim 1, further comprising one of more additives selected from the group consisting of dyes, pigments, additional fillers, dispersants, and flame retardants.

16. The article of claim 1, wherein the cured thermally conductive silicone rubber composition exhibits one or more of
a thermal conductivity of >0.3 W/m*K, >0.4 W/m*K, >0.5 W/m*K, >0.6 W/m*K, or >0.7 W/m*K;
an elongation at break of 400-1,000%, 500-1,000%, 500-800%, at least 500%, at least 550%, or at least 600%; optionally wherein the composition further exhibits
M300 modulus in a range of 0.9 to 5 MPa, 1.0-4 MPa, or >1.1 MPa;
tensile strength in a range of 1.80 to 7.8 MPa, >3.0 MPa, or >3.5 MPa;
hardness in a range of 30 to 60 Shore A, 35 to 55 Shore A, or 40 to 50 Shore A;
dielectric constant of >2.5, >3.0, or >3.5; and
dielectric strength of >14 kV/mm, >15 kV/mm, >16 kV/mm, >17 kV/mm, or >18 kV/mm.

17. The article of claim 16, comprising at least three layers including
an innermost layer comprising an electrically conductive silicone rubber composition;
an intermediate layer comprising the thermally conductive silicone rubber composition; and
an outer or outermost layer comprising an electrically conductive silicone rubber composition.

18. The article of claim 17, wherein the innermost electrically conductive liquid silicone rubber layer and outer or outermost electrically conductive liquid silicone rubber layer each independently exhibit a volume resistivity in a range of no more than 300 ohm cm, 5 ohm cm to 300 ohm cm, 10 ohm cm to 200 ohm cm, 20 ohm cm to 100 ohm cm, or <300 ohm cm, <200 ohm cm, <100 ohm cm, <75 ohm cm, or <50 ohm cm.

19. A method of making the splice article of claim 1, the method comprising
(i) obtaining the electrically conductive silicone rubber composition;
(ii) formulating the thermally conductive silicone rubber composition comprising the silicone rubber, the first thermally conductive filler, and the second thermally conductive filler as a homogenous composition;
(iii) forming the electrically conductive silicone rubber composition and the homogenous thermally conductive silicone rubber composition into a shaped article;
(iv) at least partially curing the shaped article;
(v) stretching the cured shaped article; and
(vi) maintaining the stretched, cured article in a stretched state.

20. The method of claim 19, wherein the forming comprises
molding together
a first inner layer comprising the electrically conductive silicone rubber composition; and
a second layer comprising the homogenous silicone rubber composition.

21. The method of claim 20, wherein the forming further comprises molding together the first and second layers with a third outer or outermost layer comprising an electrically conductive silicone rubber composition.

22. A thermally conductive silicone rubber composition comprising:
a silicone rubber;
a first thermally conductive filler; and
a second thermally conductive filler.

23. The composition of claim 22, wherein the silicone rubber is selected from the group consisting of liquid silicone rubber and a high consistency silicone rubber.

24. The composition of claim 23, wherein the liquid silicone rubber is a two-part liquid silicone mixture comprising a cure catalyst.

25. The composition of claim 22, wherein the first and second thermally conductive fillers are selected from the group consisting of aluminum oxide, aluminum hydroxide, fumed alumina, aluminum nitride, and boron nitride.

26. The composition of claim 25, wherein the first thermally conductive filler is selected from the group consisting of aluminum oxide (Al₂O₃) and aluminum hydroxide (Al(OH)₃), optionally wherein the aluminum oxide is calcined aluminum oxide comprising >95%, >97%, or >98% Al₂O₃.

27. The composition of claim 26, wherein the first thermally conductive filler has a particle size distribution D₉₀ in a range of 3-150 micrometers, 3-120 micrometers, 3-100 micrometers, 4-80 micrometers, or 15-50 micrometers.

28. The composition of claim 27, wherein the first thermally conductive filler has a predominant particle shape selected from the group consisting of platelets and flakes.

29. The composition of claim 25, wherein the second thermally conductive filler is a boron nitride filler.

30. The composition of claim 29, wherein the second thermally conductive filler has a particle size distribution D₉₀ in a range of 10-800 micrometers, 10-500 micrometers, 10-100 micrometers, or 12-50 micrometers.

31. The composition of claim 30, wherein the second thermally conductive filler has a predominant particle shape selected from the group consisting of platelets and flakes, or a mixture thereof.

32. The composition of claim 22, comprising 20 to 60 wt %, 30 to 55 wt %, 35 to 50 wt %, or 40 to 50 wt % of combined first and second thermally conductive fillers.

33. The composition of claim 22, wherein the weight ratio of the first conductive filler to the second conductive filler is in a ratio of 1:1 to 6:1, 2:1 to 5.5:1, 2:1 to 5.25:1, or 3:1 to 5:1.

34. The composition of claim 22, wherein the thermally conductive silicone rubber composition comprises 40-80 wt %, 45-70 wt %, 50-65 wt %, or 50-60 wt % of the silicone rubber.

35. The composition of claim 22, further comprising one of more additives selected from the group consisting of dyes, pigments, additional fillers, dispersants, and flame retardants.

36. The composition of claim 22, wherein the cured composition exhibits
a thermal conductivity of >0.3 W/m*K, >0.4 W/m*K, >0.5 W/m*K, >0.6 W/m*K, or >0.7 W/m*K;
an elongation at break of 400-1,000%, 500-1,000%, 500-800%, at least 500%, at least 550%, or at least 600%; optionally wherein the composition further exhibits
M300 modulus in a range of 0.9 to 5 MPa, 1.0-4 MPa, or >1.1 MPa;
tensile strength in a range of 1.80 to 7.8 MPa, >3.0 MPa, or >3.5 MPa;
hardness in a range of 30 to 60 Shore A, 35 to 55 Shore A, or 40 to 50 Shore A;
dielectric constant of >2.5, >3.0, or >3.5; and
dielectric strength of >14 kV/mm, >15 kV/mm, >16 kV/mm, >17 kV/mm, or >18 kV/mm.
